(19) United States
(12) Patent Application Publication
(10) Pub. No.: US 2021/0380501 A1
(43) Pub. Date: Dec. 9, 2021

(54) PHOTOACTIVE SLOW PLANT NUTRIENT RELEASE SYSTEM

(71) Applicant: Bowling Green State University, Bowling Green, OH (US)

(72) Inventors: Alexis Ostrowski, Bowling Green, OH (US); M.H. Jayan S. Karunarathna, Bowling Green, OH (US)

(73) Assignee: Bowling Green State University, Bowling Green, OH (US)

(21) Appl. No.: 17/287,817

(22) PCT Filed: Oct. 25, 2019
(86) PCT No.: PCT/US19/58024

§ 371 Date: Apr. 22, 2021

Related U.S. Application Data
(60) Provisional application No. 62/750,752, filed on Oct. 25, 2018.

(51) Int. Cl. C05G 3/40; C05G 5/35; C05G 5/18; C05G 1/00; C05F 3/00

(52) U.S. Cl. CPC C05G 3/40; C05G 5/35; C05F 3/00; C05G 1/00; C05G 5/18

(57) ABSTRACT

A slow releasing fertilizer system comprising polysaccharide-based hydrogel beads, and methods of making and using the same, are described.

### RELATED APPLICATIONS

This application claims priority to U.S. Provisional Application No. 62/750,752 filed under 35 U.S.C. § 111(b) on Oct. 25, 2018, the disclosure of which is incorporated herein by reference in its entirety for all purposes.

### STATEMENT REGARDING FEDERALLY SPONSORED RESEARCH

This invention was made with no government support. The government has no rights in this invention.

### BACKGROUND

Global agricultural food production has increased significantly to provide food for the increasing world population. To achieve this, more land area has been converted into crop and pasture lands over the last three centuries. In combination with the usage of fertilizers, usage of genetically modified seeds and introduction of advanced machinery in agriculture have also played a role in this achievement.

During the last five decades, global fertilizer consumption has increased several magnitudes with the intensified agriculture. Furthermore, it has been predicted that the world fertilizer usage will further increase significantly in the upcoming decades. Phosphate is one of the important macronutrients for plants and crops, and it is ubiquitous in soil. Mined rock phosphates are the major source of phosphate for phosphate fertilizers. Currently, phosphates are mined at a global rate of about 20 million metric tonnes per year, and almost all the phosphorus used in agriculture is from these mined phosphates. However, with the increasing demand for phosphate, increasing cost of extraction, and declining of the quality of phosphate reserves, phosphate is becoming a limited resource. It is speculated that the mined rock phosphates will be completely depleted in the next 50-100 years. Due to these phosphates being a limited resource, it is important to recycle and use phosphates efficiently.

Chemical fertilizers have become a must in modern day agriculture to supply the increasing demand for food. However, a significant number of conventional chemical fertilizers that are applied to agricultural fields are not accessible for the crops due to losses from runoff and other factors. Nutrient runoff and excessive leaching are responsible for various environmental issues including air and ground water pollution as well as harmful algal blooming. Thus, current fertilizers are being applied on agricultural fields with only a portion of the fertilizer being absorbed by the plants. A significant fertilizer release to the environment results in various environmental problems including groundwater pollution, eutrophication of lakes and rivers, air pollution, soil acidification, salinization, and accumulation of toxic elements.

The use of controlled release fertilizers is one way of addressing the environmental issues associated with chemical fertilizers. There are different kinds of controlled release fertilizer systems currently known. Unfortunately, many of these systems use synthetic polymers along with natural substances. Furthermore, in some cases, synthesis schemes with the use of expensive chemicals that consume a lot of time are involved in making these substances. This also contributes to the growing problem of plastic pollution. There is still a limited amount of slow releasing fertilizer systems (SRFSs) used in industrial agriculture because of their high cost.

Given the above, there is a need in the art for new and improved fertilizer systems.

### SUMMARY

Provided herein is a slow releasing fertilizer system comprising a hydrogel bead comprising a polysaccharide and a metal species; and one or more plant nutrients encapsulated in the hydrogel bead; wherein the hydrogel bead is capable of releasing the one or more plant nutrients upon exposure to light at a wavelength of shorter than 450 nm.

In certain embodiments, the metal species comprises iron (III). In certain embodiments, the metal species comprises a combination of iron and calcium. In certain embodiments, the metal species comprises a combination of iron and aluminum.

In certain embodiments, the hydrogel bead comprises at least about 90% water. In certain embodiments, the hydrogel bead comprises at least about 96% water.

In certain embodiments, the metal species is present in the hydrogel bead in a range of from about 0.01% by weight to about 0.3% by weight. In certain embodiments, the hydrogel bead contains about 0.2% by weight or less of the metal species.

In certain embodiments, the one or more plant nutrients comprises a phosphate. In certain embodiments, the one or more plant nutrients comprises a nitrate. In certain embodiments, the one or more plant nutrients comprises ammonium. In certain embodiments, the one or more plant nutrients comprises two or more of a phosphate, a nitrate, and ammonium.

In certain embodiments, the polysaccharide is present in the hydrogel bead in an amount ranging from about 0.25% by weight to about 3% by weight. In certain embodiments, the polysaccharide is present in the hydrogel bead in an amount of about 1% by weight.

In certain embodiments, the polysaccharide comprises a polyuronic acid. In particular embodiments, the polyuronic acid comprises alginate, pectate, pectin, xanthan gum, oxidized starch, hyaluronate, mannuronate, or a combination thereof. In certain embodiments, the hydrogel bead further comprises a second polysaccharide or water soluble polymer. In particular embodiments, the second polysaccharide comprises agarose, chitosan, or a combination thereof. In particular embodiments, the water soluble polymer comprises acrylamide or acrylic acid. In particular embodiments, the polysaccharide and the second polysaccharide are present in the hydrogel bead in a total amount ranging from about 0.25% by weight to about 3% by weight. In particular embodiments, the polysaccharide and the second polysaccharide are present in the hydrogel bead in a total amount of about 1% by weight.

In certain embodiments, the hydrogel bead has a phosphate uptake capability ranging from 0.6 to 1.5 mgg⁻¹ in the pH range of from 4.0 to 11.0 from a 800 ppm phosphate solution. In certain embodiments, the hydrogel bead has above 99% phosphate uptake from a 100 ppm phosphate solution. In certain embodiments, the hydrogel bead has a phosphate uptake capability of about 1.2 mgg⁻¹ from a raw manure solution.

Further provided is a method of delivering nutrients to a plant, the method comprising encapsulating one or more plant nutrients in a polysaccharide-based hydrogel bead to form a loaded hydrogel bead; and exposing the loaded hydrogel bead to light having a wavelength shorter than 450 nm in the vicinity of a plant to deliver the one or more plant nutrients to the plant. In certain embodiments, the light is natural sunlight. In certain embodiments, the light is artificial light.

Further provided is a method for making a nutrient-loaded hydrogel, the method comprising dissolving a polysaccharide in water to make a polysaccharide solution; combining the polysaccharide solution with an iron chloride solution to form hydrogel beads; separating the hydrogel beads from solution; and soaking the hydrogel beads in a nutrient solution for a period of time to obtain a nutrient-loaded hydrogel. In certain embodiments, the soaking comprises mechanical shaking for the period of time. In certain embodiments, the method further comprises filtering the nutrient-loaded hydrogels out of solution. In certain embodiments, the polysaccharide comprises a polyuronic acid. In particular embodiments, the polyuronic acid comprises alginate, pectate, pectin, xanthan gum, gum Arabic, oxidized starch, hyaluronate, mannuronate, or a combination thereof. In particular embodiments, the polysaccharide further comprises chitosan, agarose, or a combination thereof. In certain embodiments, the nutrient solution is a manure solution. In certain embodiments, the nutrient solution comprises phosphate ions, nitrate ions, or ammonium ions.

Further provided is a method for reclaiming phosphate, the method comprising soaking hydrogel beads in an animal waste solution so as to cause the hydrogel beads to uptake phosphate from the animal waste solution and thereby obtain phosphate-loaded hydrogel beads, and using the phosphate-loaded hydrogel beads to fertilize a plant. In certain embodiments, the hydrogel beads comprise iron. In certain embodiments, the hydrogel beads comprise a polysaccharide. In particular embodiments, the polysaccharide comprises a polyuronic acid. In particular embodiments, the polyuronic acid comprises alginate, pectate, pectin, xanthan gum, gum Arabic, oxidized starch, hyaluronate, mannuronate, or a combination thereof. In particular embodiments, the polysaccharide further comprises chitosan, agarose, or a combination thereof.

Further provided is a method for reducing blossom end rot in a tomato plant, the method comprising treating a tomato plant with a fertilizer system comprising hydrogel beads loaded with phosphate, wherein the hydrogel beads comprise a polysaccharide and a metal species, and wherein the hydrogel beads are capable of releasing the phosphate and calcium upon exposure to light.

Further provided is a kit for delivering nutrients to a plant, the kit comprising a first container housing polysaccharide-based hydrogel beads, and a second container housing one or more plant nutrients. In certain embodiments, the one or more plant nutrients are in the form of a manure solution.

Further provided is a slow releasing fertilizer system comprising a hydrogel bead comprising a polysaccharide and a metal species; and one or more plant nutrients encapsulated in the hydrogel bead; wherein the metal species is capable of being oxidized or reduced upon exposure to light so as to cause a release of the one or more plant nutrients from the hydrogel bead.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIGS. 1A-1D: Illustrations depicting a slow release nutrient fertilizer system providing nutrients to a plant. FIG. 1B shows the photo-controlled phosphate release from Fe(III)-alginate hydrogel beads. FIG. 1C shows an illustration depicting nutrients captured from aqueous waste being delivered to a plant through hydrogel beads. FIG. 1D shows a process of forming hydrogel beads, loading the hydrogel beads with phosphate, and degrading the hydrogel beads through exposure to light, releasing phosphate and iron.

PRIOR ART FIGS. 2A-2B: Photochemistry of Fe-(III)-α-hydroxy acids (FIG. 2A) and Fe(III)-polyuronates (FIG. 2B). FIG. 2B shows the photochemical reaction between Fe(III) and polyuronate.

FIG. 3: Non-limiting example embodiments of hydrogel beads in accordance with the present disclosure are mostly water.

FIGS. 4A-4B: Photographs of hydrogel beads formed from alginate and iron chloride (specifically, alginate G-0.1 M Fe) (FIG. 4A), and a single alginate G-0.1 M Fe hydrogel bead (FIG. 4B).

FIG. 5: Photograph showing example hydrogel beads removed from a column after being loaded with phosphate from the manure solution.

FIG. 6: Illustration of alginate-Fe beads uptaking phosphate.

FIGS. 7A-7B: Photograph of example hydrogel beads prepared with raw cow manure (FIG. 7A), and graph showing phosphate absorption from cow manure (FIG. 7B).

FIG. 8: Illustration depicting process of reclaiming phosphate from animal manure and using the reclaimed phosphate to fertilize plants that feed the animals to produce more manure.

FIGS. 9A-9E: Phosphate uptake by different hydrogel beads in 100 ppm phosphate solution (pH-7.0) (FIG. 9A), and phosphate uptake from manure solution with 727 ppm phosphate (average pH=7.6+/−0.1) compared to the phosphate uptake from 800 ppm phosphate solution (pH-7.0) (FIG. 9B).

FIG. 9B demonstrates that alginate beads can uptake phosphates from raw manure solutions. FIGS. 9C-9D show a photograph showing alginate-0.1 M FeCl₃ beads after soaking in a raw manure solution for 24 hours (FIG. 9C), and a graph showing ammonium ion uptake of different alginate beads from raw manure solution with ammonium concentration of 1417 ppm, pH=7.6±0.1 (FIG. 9D).

FIG. 10: Photograph showing a column packed with hydrogel beads and cow manure.

FIGS. 11A-11E: Phosphate uptake (mg of phosphate absorbed per g of gels) by alginate beads from 800 ppm phosphate solution changes depending on type of polysaccharide (FIG. 11A), concentration of FeCl₃ solution used to prepare the hydrogels (FIG. 11B), introduction of other cations (from alum) in addition to the FeCl₃ (FIG. 11C), and change in pH of the phosphate solution (FIG. 11D). (pH=7 for all other uptake studies). FIG. 11E shows variation of phosphate uptake of different alginate beads from 800 ppm phosphate solutions at various pH values. Plots are average of 3 samples with error bars+/−standard deviations.

FIGS. 12A-12B: Phosphate uptake from different hydrogel beads in 100 ppm phosphate solution (pH=7.0) (FIG. 12A) and manure solution with 225-300 ppm phosphate (FIG. 12B).

FIGS. 13A-13C: Photographs (FIGS. 13A-13B) and graph (FIG. 13C) of kale plant trials with a slow release fertilizer system, showing non-toxicity toward plant germination and plant growth. The photograph in FIG. 13B shows the growth of kale plants with hydrogel beads in the soil over about 2 weeks. The hydrogel beads were non-toxic toward seed germination, and non-toxic toward plant growth. The hydrogel beads degraded within a couple of weeks. FIG. 13B shows that hydrogel beads are degradable. FIG. 13B shows photographs the day of planting (left), in which the hydrogel beads are visible on top of the soil, and two weeks later (right), in which the hydrogel beads have clearly degraded. FIG. 13C shows above ground biomass analysis of kale plants after 6 weeks grown under three different growth conditions, with phosphate-loaded beads (green), control beads (orange), or just soil (black).

FIGS. 14A-14B: Phosphate release from hydrogel beads under different light conditions (FIG. 14A), and hydrogel bead degradation under different light conditions (FIG. 14B). FIG. 14C shows Fe²⁺ generation correlates with the phosphate release. The hydrogel beads degrade differently. (FIG. 14B.)

FIGS. 15A-15E: Graphs (FIGS. 15A-15C) and photographs (FIG. 15C) showing that dehydration of the hydrogel beads slows down the phosphate release from the hydrogel beads. Light stimulates the phosphate release from alginate beads. The photograph on the left in FIG. 15C shows the hydrogel beads before drying, and the photograph on the right in FIG. 15C shows the hydrogel beads after drying. As seen in FIG. 15B, there was very little phosphate release (˜1%) in the dark. FIG. 15D shows phosphate release from dry alginate 61% M-0.1 M Fe hydrogel beads. FIG. 15E shows Fe²⁺ generation from dry alginate 61% M-0.1 M Fe hydrogel beads.

FIGS. 16A-16D: Graph (FIG. 16A, 16D) and photographs (FIGS. 16B-16C) from tomato plant trials with a slow release fertilizer system in accordance with the present disclosure. The tomato plant trials demonstrated the success of the controlled release fertilizer system. FIG. 16A is a graph showing total fruit formation in tomato plants under each condition counted every week. FIG. 16B shows tomato plant trial in greenhouse conditions with dark condition for hydrogel beads provided using aluminum foil. FIG. 16C is a photograph showing tomato harvest of a single day with a small ripened tomato harvested from a tree of condition 2 shown at the bottom right. FIG. 16D is a graph showing average plant height of tomato plants of each condition measured weekly since they started showing significant differences.

FIGS. 17A-17B: Graph showing the average weight of ripened tomatoes under light or dark conditions with or without loaded hydrogel (fertilizer) beads (FIG. 17A), and photographs showing blossom end rot in tomatoes from plants treated with fertilizer solution due to the competition for water and nutrients between the fruits and the rest of the tree (FIGS. 17B-17C).

FIGS. 18A-18C: FTIR spectra of alginate-alum beads before and after phosphate uptake annotated to highlight the P═O stretching frequencies. FIGS. 18B-18C show SEM images of an alginate G-alum Fe(III) bead prepared with alginate 53% M, alum, and 0.05 M FeCl₃. FIG. 18B shows the exterior of the bead, and FIG. 18C shows the interior of the bead.

FIGS. 19A-19B: Energy dispersive X-ray spectra (at 20 kV) of freeze-dried alginate G-alum-0.05 M Fe beads before (FIG. 19A) and after (FIG. 19B) phosphate uptake.

FIGS. 20A-20B: SEM images of alginate G-alum-0.05 M Fe bead soaked in phosphate exterior (FIG. 20A) and interior (FIG. 20B).

FIG. 21: Photograph showing kale seed germination experiment under three different conditions. Left: phosphate-loaded beads. Middle: control beads. Right: just soil.

FIG. 22: Enhanced plant growth in kale plants treated with phosphate beads (back row) compared to the control plants (front row) after 6 weeks from transplanting in pots.

FIGS. 23A-23B: Kale plant trials with phosphate loaded hydrogel beads (FIG. 23A). FIG. 23B shows nutrient release from hydrogel enhances plant growth.

FIGS. 24A-24F: Ammonium ion uptake of different alginate-Fe beads from a 100 ppm solution at pH=7 (FIG. 24A), nitrate uptake of different alginate-Fe beads from a 100 ppm solution at pH=7 (FIG. 24B), and ammonium, nitrate, and phosphate ion uptake for alignate-0.1 M FeCl₃ beads from a solution with 100 ppm concentration of each ion at pH=7 (FIG. 24C). FIG. 24D shows a comparison of % uptake of phosphate, ammonium, and nitrate from 100 ppm mixed solution for various alginate hydrogel beads. FIG. 24E shows ammonium uptake from a 100 ppm ammonium solution and from a mixed nutrient 100 ppm solution. FIG. 24F shows nitrate uptake from a 100 ppm nitrate solution and from a mixed nutrient 100 ppm solution. The hydrogel beads are good at uptaking phosphate over ammonium and nitrate. The size and charge of the ion play a role in uptake by the hydrogel beads.

FIG. 25: Graph showing average plant height of tomato plants of each condition measured weekly since they started showing significant differences.

FIGS. 26A-26C: Photograph showing tomato leaves from different treatments with significant changes in their green color visible to the naked eye (FIG. 26A), photograph showing chlorophyll extracted from tomato leaves of each condition showing differences visible to the naked eye (FIG. 26B), and graph showing total chlorophyll content of tomato leaf samples from different conditions (FIG. 26C).

FIG. 27: Graph showing average total biomass for tomato plants from different conditions.

FIGS. 28A-28B: Photographs showing 0.075 M Ca/0.025 M Fe hydrogel beads degraded after 2-3 days (FIG. 28A) and in comparison to 0.1 M Fe and 0.1 M Ca hydrogel beads (FIG. 28B).

FIGS. 29A-29C: Photographs showing example hydrogel beads exposed to simulated rain.

FIG. 30: Photograph of the tip of a column packed with hydrogel beads with a manure solution passing through it.

FIG. 31: Photograph showing a manure solution prior to passing through a packed column in the beaker on the left, and the manure solution after having passed through the packed column in the beaker on the right.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Slow releasing fertilizer systems (SRFSs) are important to release the nutrients in a controlled manner and minimize waste to keep the fertilizer cost at a lower level. The challenge is to create a controlled-release fertilizer using non-petroleum based plastics and waste products. Wastewater and liquid animal wastes generated from agricultural fields, animal farms, and certain industries are rich in different nutrients including phosphates and they should be purified before releasing back to the environment to avoid the environmental issues. Due to the fact that phosphates are becoming a limited resource, it is important to recycle and use phosphates efficiently. Several attempts have been made to address the negative environmental impact of phosphate pollution and to recycle phosphates with different approaches, including phosphate removal from wastewater by electrocoagulation or electrodialysis, a hybrid microfiltration-forwards osmosis membrane bioreactor process, and using different absorbents systems developed with zeolite, and red mud. In addition, methods for phosphate recovery from animal manure have also been developed. A slow release fertilizer can even be created by reclaiming phosphate from cow dung-derived engineered biochar. However, while these methods may function well for phosphate capture, there is not controlled release on demand from these known systems. In accordance with the present disclosure, phosphate from wastewater or animal manure can be captured in a slow release fertilizer system that controllably releases the phosphate upon exposure to light.

One way of recycling phosphates is to reclaim phosphates from animal waste and use them in agricultural fields as fertilizers. Reclaiming and recycling phosphate from animal waste is an attractive solution because agriculture and livestock are major sources of phosphate pollution. Globally, the production of primary and manufactured goods and serves from crops and livestock accounts for 91% of the world's total blue water consumption (including fresh surface and ground water). In addition, when animal waste is used as fertilizer, not all of the phosphate and nitrate nutrients are absorbed by the plants. Depending on soil type, rainfall, and elevation, significant amounts of phosphate can leach into the environment, contributing to an array of ecological and human health problems such as harmful algal blooms. The use of a controlled release fertilizer system is one way of addressing the environmental issues associated with phosphate runoff. Many conventional controlled release fertilizer systems use synthetic polymers in combination with natural substances, which can slow waste and pollution rates. However, the use of petroleum-based materials in fertilizer systems and application in agricultural fields may result in other environmental issues. Therefore, it would be advantageous to recycle nutrients such as phosphates from wastewater and animal waste generated from agricultural fields, animal farms, and certain industries using environmentally-friendly or natural materials. These recycled nutrients can then be applied to agricultural fields as fertilizer.

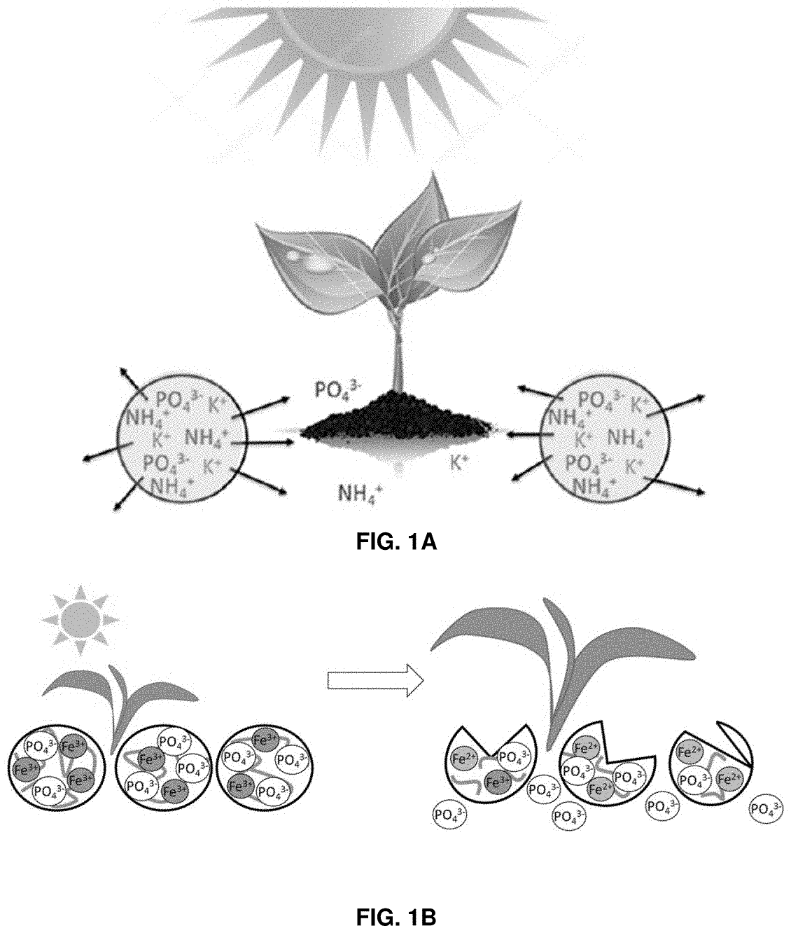

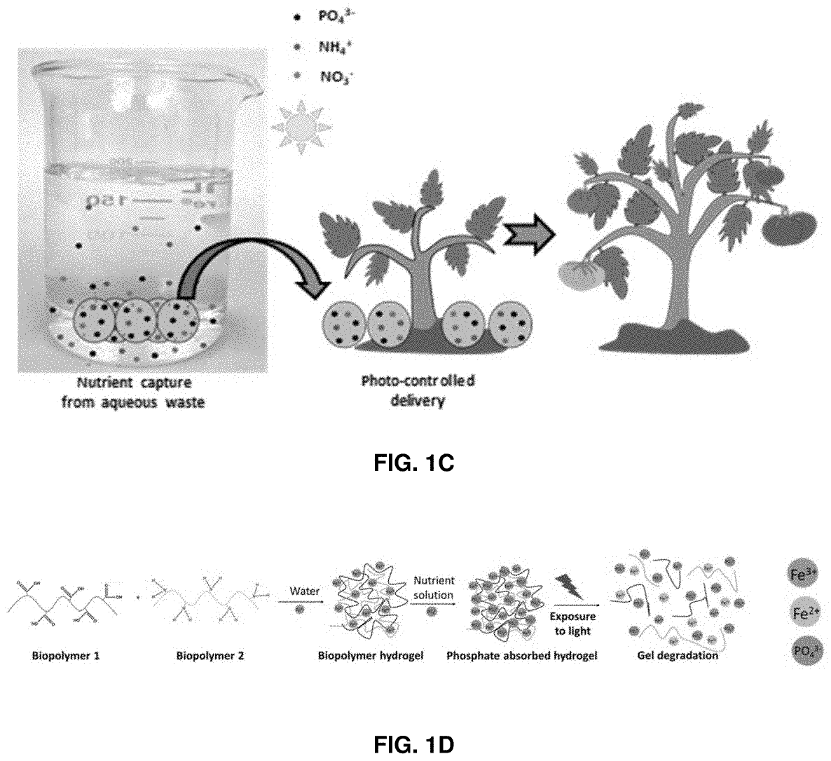

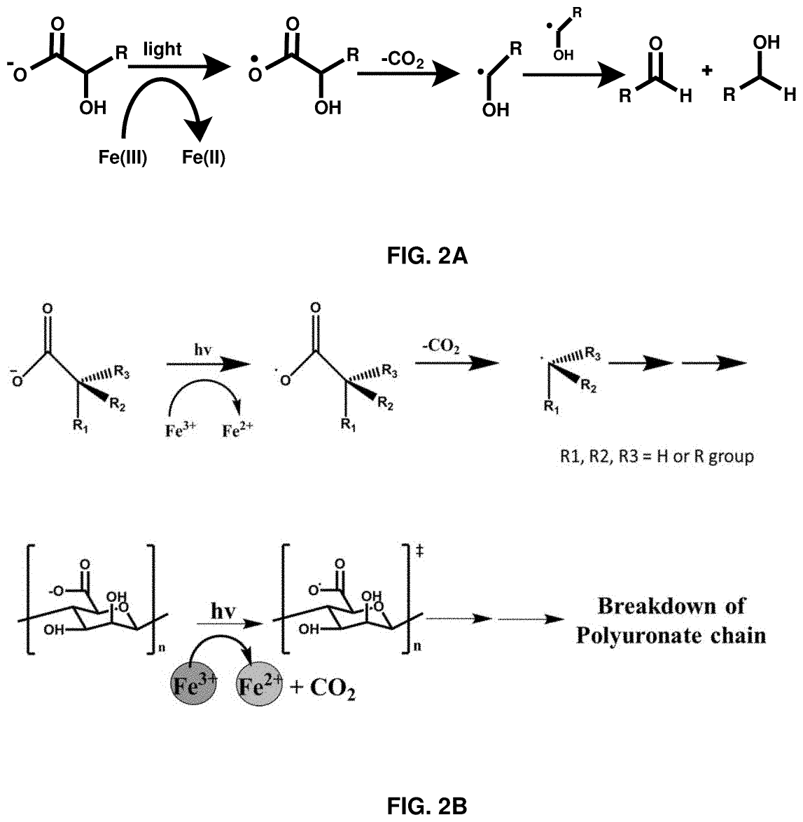

The controlled delivery of small molecules from hydrogels using Fe(III)-carboxylate photochemistry is possible in polysaccharide-based hydrogel materials. The photochemical reaction between Fe(III) and polysaccharides shows controllable degradation and release. As shown and described herein, this can be harnessed to develop Fe(III)-polysaccharide gels that can absorb nutrients such as phosphate from waste and controllably release such nutrients with light. (FIGS. 1A-1D.) By using biodegradable and relatively low-cost polysaccharides, controlled photo-release fertilizers can be created that may be a solution to the environmental issues that stem from animal agriculture. As shown in the examples herein, different polysaccharide-based hydrogel beads can be used for phosphate and other nutrient uptake from artificial aqueous wastes solutions and raw animal waste solutions, and for the controlled delivery of these nutrients.

A photochemical reaction between iron (III) and poly-carboxylate complexes, more specifically α-hydroxy acid-containing complexes, has been demonstrated previously. The ligand-to-metal charge transfer taking place in this reaction reduces iron (III) to iron (II), and the decarboxylation generates a polycarboxylate radical species. Hydrogels have the ability to controllably deliver small molecules using this iron (III)-carboxylate photochemistry.

Provided herein are polysaccharide-based hydrogel beads useable for nutrient uptake from artificial aqueous solutions and other sources such as, but not limited to, raw manure solutions. The nutrients may include phosphates, nitrates, ammonium, and combinations thereof. The hydrogel beads are useful as fertilizer systems, releasing the phosphate and/or other nutrients upon exposure to light and otherwise naturally over time through biodegradation of the hydrogel beads. The phosphate uptake capacity of different types of hydrogel beads at different pH values has been evaluated, as described in the examples herein. Plant trials have been carried out with such phosphate loaded hydrogels to demonstrate the phosphate release under natural conditions and the biodegradability of the fertilizer system. As described in the examples herein, the slow release fertilizer systems have been tested in plants such as kale and tomatoes, and have shown to have no toxicity to the plants and near complete degradation after about two weeks. Moreover, the fertilizer systems have shown an ability to release plant growth nutrients, making them available to the plants.

Fe(III)-carboxylate photochemistry is known in the art, as depicted in PRIOR ART FIGS. 2A-2B, which show the photochemistry of Fe-(III)-α-hydroxy acids and Fe(III)-polyuronates, respectively. For example, it is possible to use light to control the surface modification of certain iron-containing materials, as described, for instance, in U.S. application Ser. No. 15/212,233, incorporated herein by reference. In accordance with the present disclosure, Fe(III)-carboxyalte photochemistry can be harnessed to provide slow release fertilizer systems that release nutrients over time upon exposure to sunlight. Moreover, the fertilizer systems can be green fertilizer systems comprising biodegradable polysaccharides that do not pose environmental concerns (unlike conventional chemical fertilizers). The fertilizer systems may uptake and deliver one or more plant growth nutrients including, but not limited to, phosphates (PO₄³⁻), ammonium (NH₄⁺), and nitrates (NO₃⁻).

In general, hydrogel beads can be prepared by simply dropping a polymer solution into a metal ion solution. The polymer solution may be composed of a polysaccharide, or may be a mixture of polysaccharides, or a mixture of a polysaccharide and other water-soluble polymers. Mixtures can be made to create gels. At least one component of the mixture is a polysaccharide, but other components can be either additional polysaccharides or one or more water-soluble polymers such as acrylamide or acrylic acid. Suitable polysaccharides include polyuronic acids, such as, but not limited to, alginate, pectate, pectin, xanthan gum, gum Arabic, oxidized starch, hyaluronate, mannuronate, or combinations thereof. Suitable additional polysaccharides include, but are not limited to, chitosan, agarose, or combinations thereof. Alginate, as one example, is a natural polysaccharide that may be extracted from brown algae. Chitosan, as another example, may be produced by treating the chitin shells of crustaceans with an alkaline substance. The polysaccharide may be purified, or may be sourced from, e.g., waste material, without purification. Furthermore, although biodegradable, environmentally friendly polysacchardies are described for example purposes, it is understood that the polymer in the hydrogel beads does not need to be biodegradable or environmentally friendly, and such other polymers are encompassed within the scope of the present disclosure. As one non-limiting alternative example, the polymer may be an acrylamide or acrylic acid.

The metal ion solution may be, for example, iron(III) chloride. However, other metal ion solutions are possible and encompassed within the scope of the present disclosure. Furthermore, though the photochemical conversion of Fe²⁺ to Fe²⁺ is described for example purposes, it is understood that other photochemical conversions may alternatively be employed. Moreover, the hydrogel beads may include more than one metal species. In some non-limiting example embodiments, the hydrogel beads include iron and calcium. When the hydrogel beads include iron and calcium, the photo release of nutrients from the hydrogel beads is faster. The iron and calcium may be present at a 1:1 ratio, or may be present at other ratios. In some example embodiments, the hydrogel beads include iron and aluminum. The presence of aluminum together with iron enhances the nutrient uptake, and does not interfere with the photorelease of nutrients. In other embodiments, the hydrogel beads include iron as the only metal present.

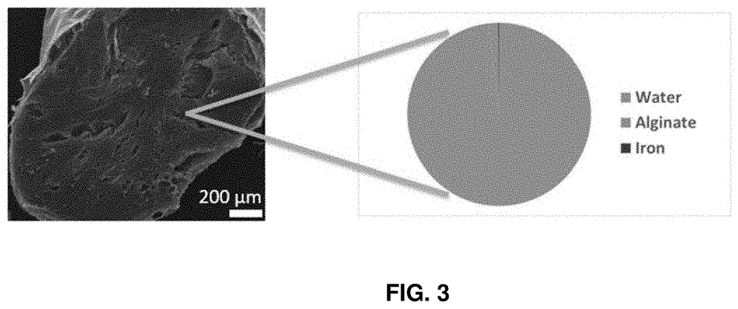

The resulting hydrogel beads, which may be filtered or otherwise separated out from solution, are mostly water, with very low metal content. (FIG. 3.) The metal species may be present in the hydrogel bead in the range of from about 0.01% by weight to about 0.3% by weight of the hydrogel bead. In some example embodiments, the metal content is about 0.2% by weight of the hydrogel bead. In other embodiments, the metal content is about 0.1% by weight of the hydrogel bead. In some embodiments, the hydrogel beads are at least about 85% by weight water. In some embodiments, the hydrogel beads are at least about 90% by weight water. In other embodiments, the hydrogel beads are at least about 96% by weight water.

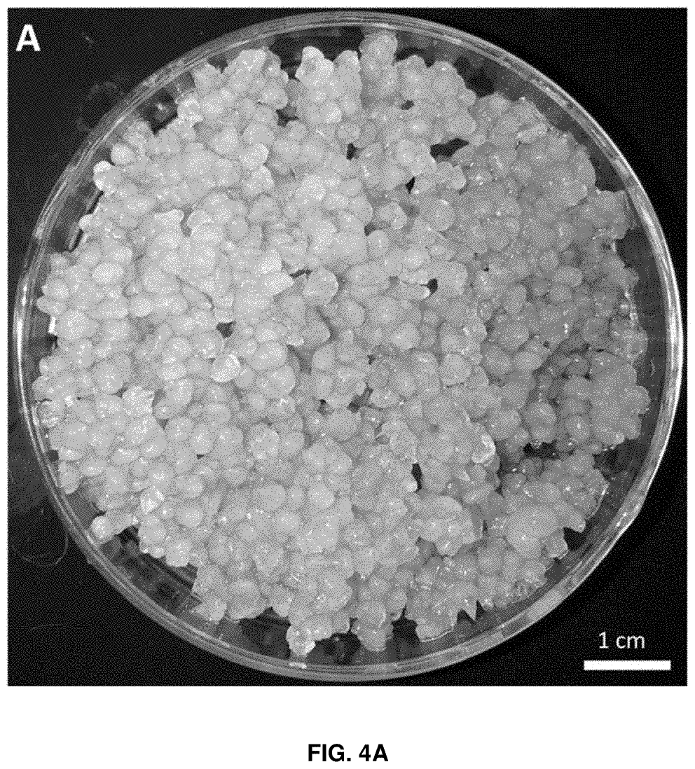

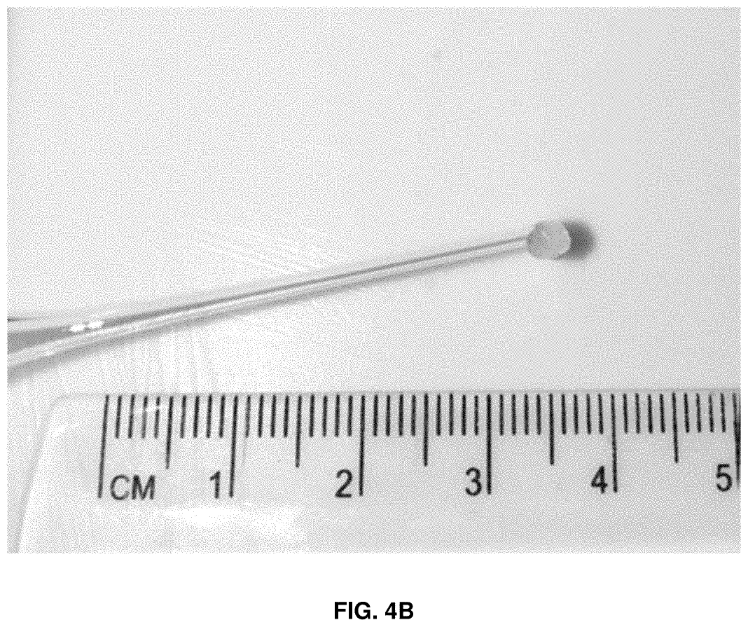

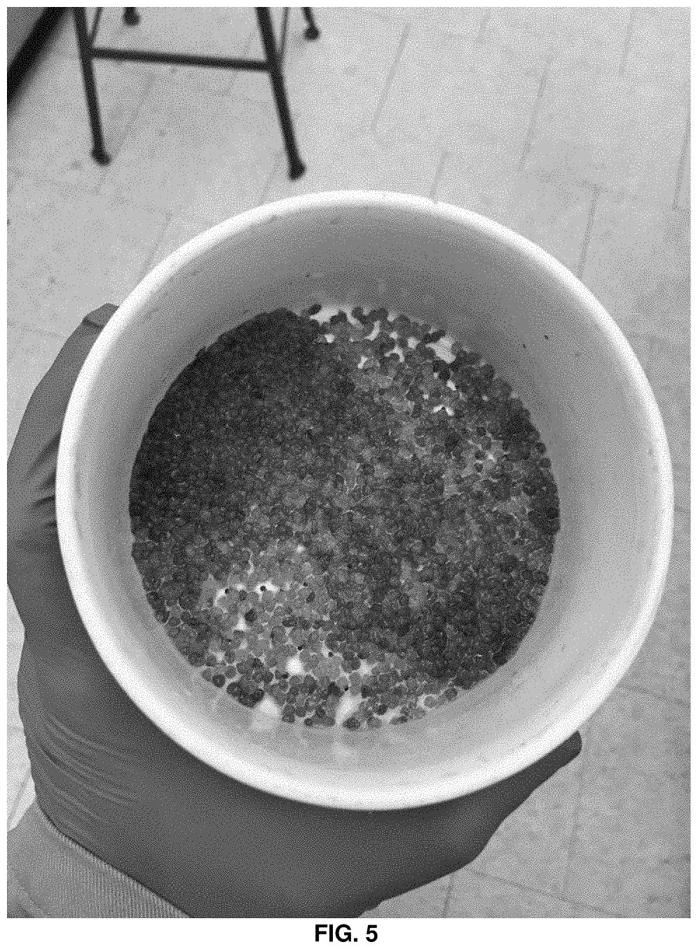

FIGS. 4A-4B show photographs of example hydrogel beads formed from alginate and iron chloride. In these examples, the hydrogel beads are spherical and approximately 3-4 mm in diameter with an orange color, indicative of Fe(III). However, it is not strictly necessary that the hydrogel beads be spherical, have a diameter of 3-4 mm, or be orange in color. Other shapes, sizes, and colors are entirely possible and encompassed within the scope of the present disclosure. In fact, though the term “hydrogel beads” is used herein, the composition containing a polysaccharide and a metal species may be formed into cakes instead of beads. For example, for large scale production of the hydrogel beads, it may be economically beneficial to form the composition into cakes instead of beads.

As further non-limiting examples, the hydrogel beads described in U.S. application Ser. No. 15/212,233, incorporated herein by reference in its entirety for all purposes, may be utilized to prepare a fertilizer system as described herein by loading the hydrogel beads with one or more plant growth nutrients.

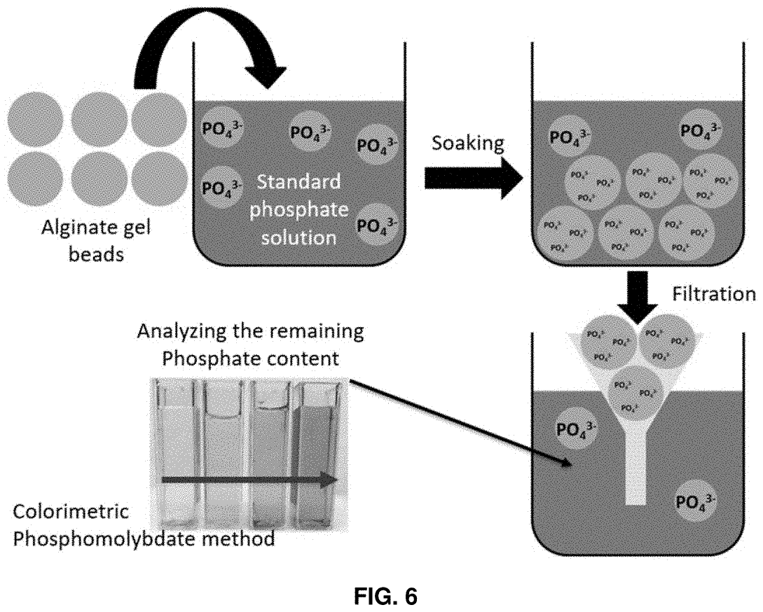

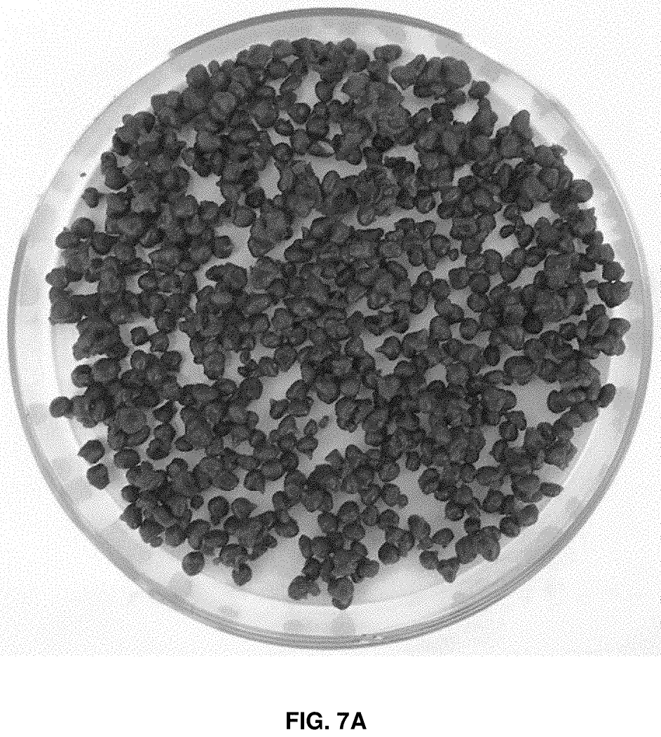

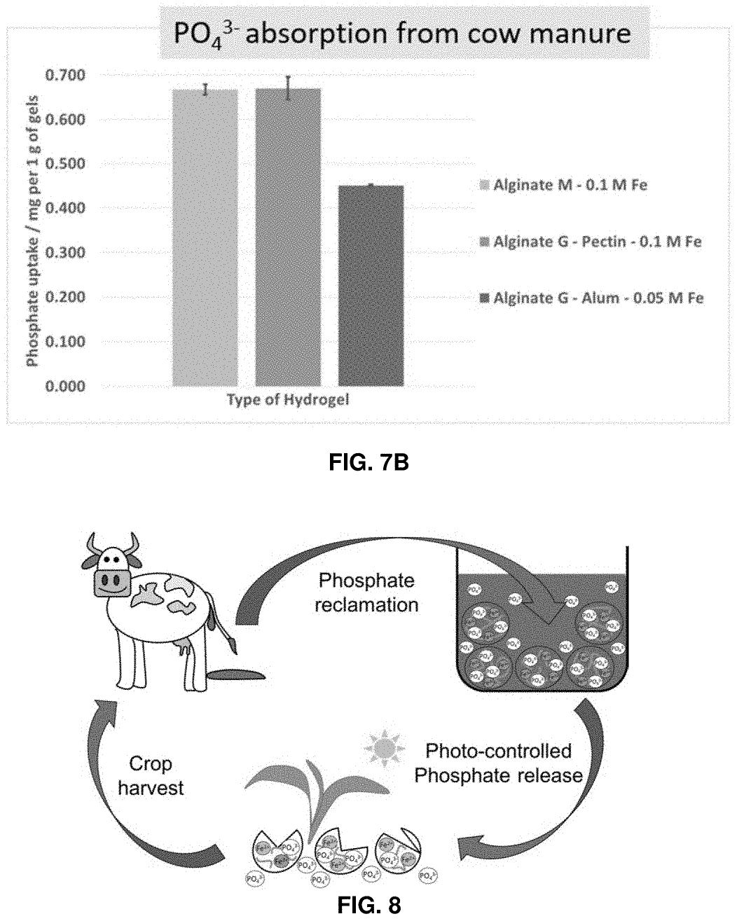

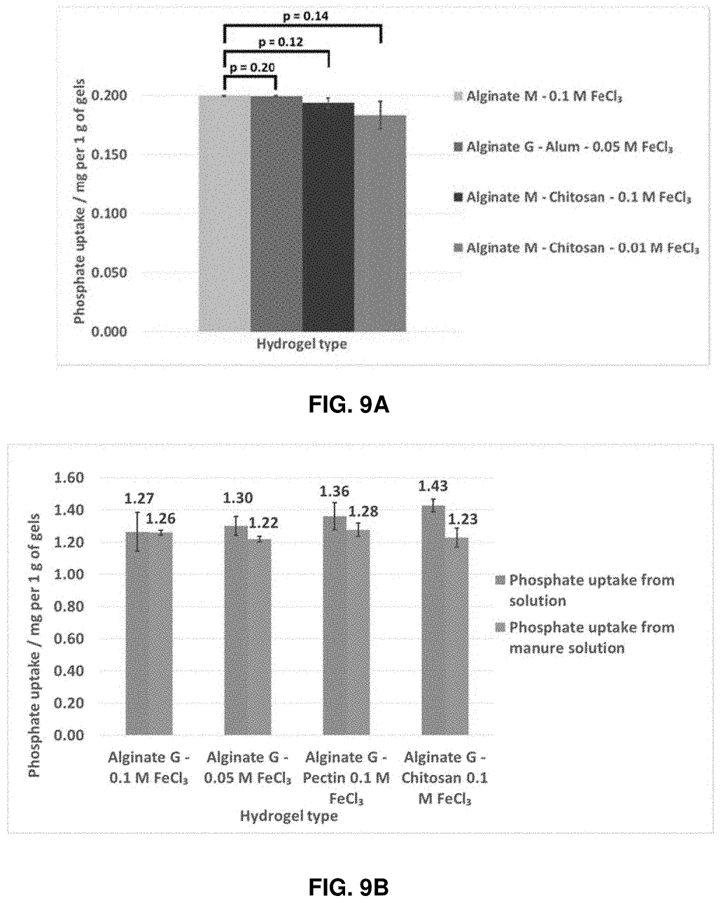

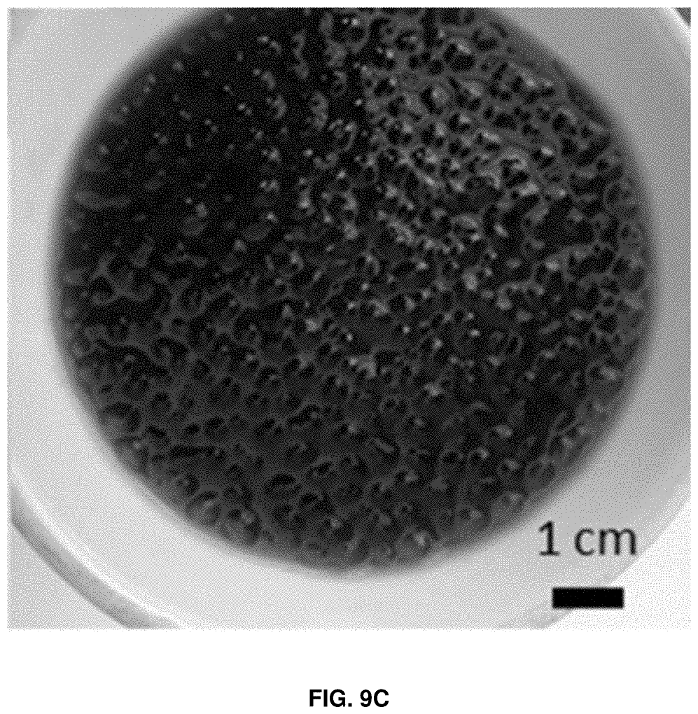

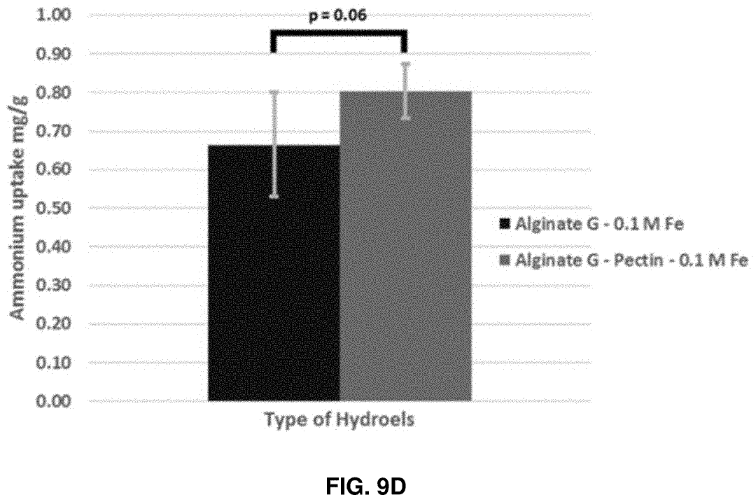

The hydrogel beads can be loaded with one or more plant growth nutrients, such as phosphates, nitrates, or ammonium, through a variety of ways. For example, the hydrogel beads can be exposed to a mixed solution containing multiple nutrients, or to a concentrated solution of only one nutrient. FIG. 6 shows an illustration of alginate-Fe beads uptaking phosphate. Advantageously, the hydrogel beads can be loaded with plant growth nutrients through exposure to a manure solution, for instance from animal manure. The use of raw manure to trap important nutrients in the gel beads is a good approach to trap all the nutrients as well as to address the problems associated with disposing of manure waste generated from agricultural farms. FIG. 7 shows a photograph of hydrogel beads prepared with raw manure. FIG. 8 shows an illustration depicting a cyclic process of utilizing manure to reclaim phosphate, releasing the phosphate to plants, and feeding the harvested plants to animals to produce more manure to be used to reclaim phosphate. FIG. 9 shows that alginate beads can uptake phosphates from raw manure solutions. Entrapment of important plant nutrients in iron(III)-polysaccharide beads from waste products provides for a green slow release fertilizer system.

In one non-limiting example embodiment, the hydrogel beads may be situated at an animal farm, where they can be used to reclaim phosphate and other nutrients from animal manure, such as horse manure, that may not be useable for other applications because of concerns about diseases. Thus, the nutrient uptake capability of the hydrogel beads makes them useful for adding value to otherwise un-usable waste.

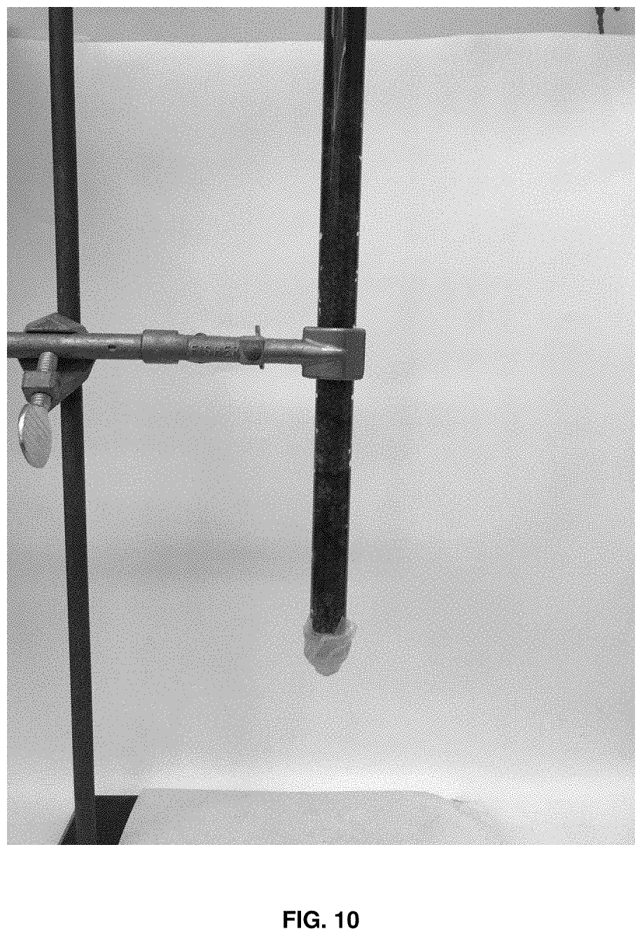

In some embodiments, the animal waste or other nutrient solution may be flowed through a packed column of hydrogel beads, from which process the hydrogel beads may absorb nutrients from the animal waste or other nutrient solution. The water collected through the column can be sent to wastewater treatment. FIG. 10 shows a photograph of a column packed with hydrogel beads and cow manure. The packed column of ferric polysaccharide beads absorbs nutrients from animal waste, which is an econimcal source of fertilizer. The loaded hydrogel beads can be easily removed from the column to be used as fertilizers. The loaded hydrogel beads show slow/controlled release of nutrients with light.

In alternative embodiments, the hydrogel beads may be produced by combining a polysaccharide with a nutrient solution prior to adding the metal ion solution.

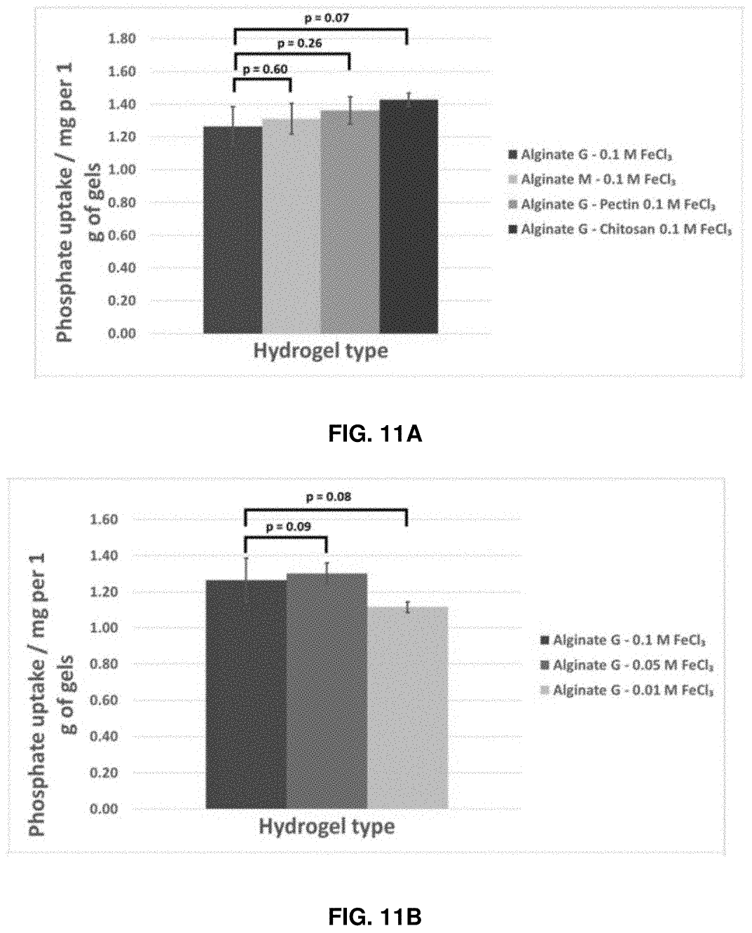

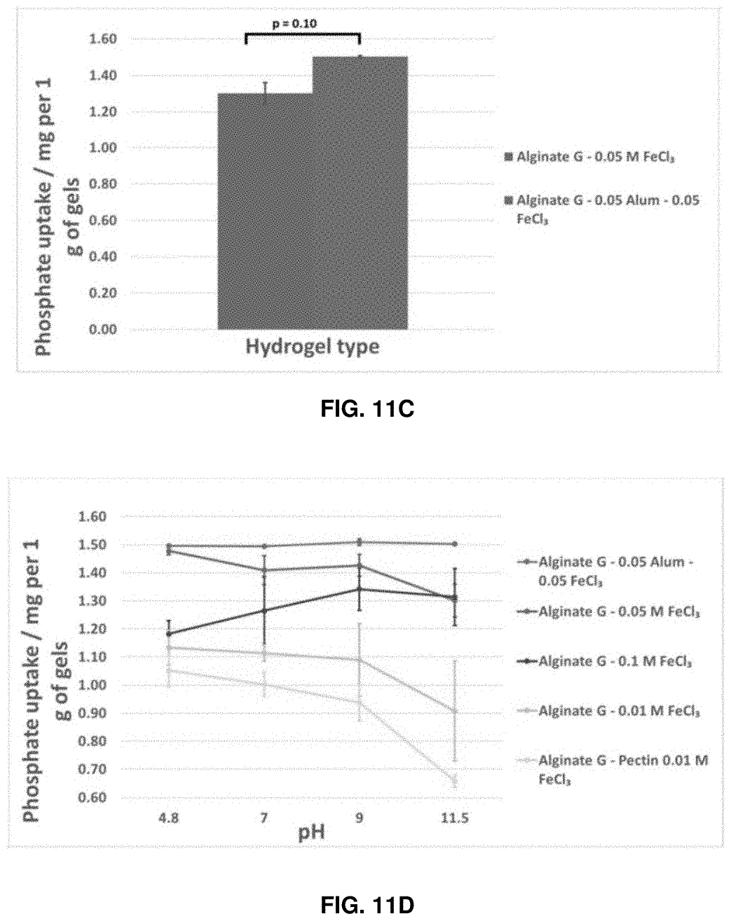

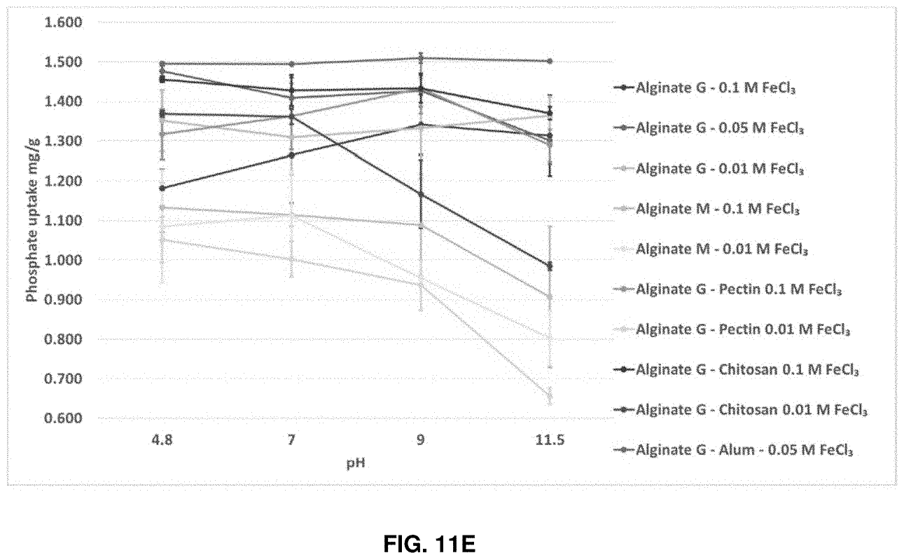

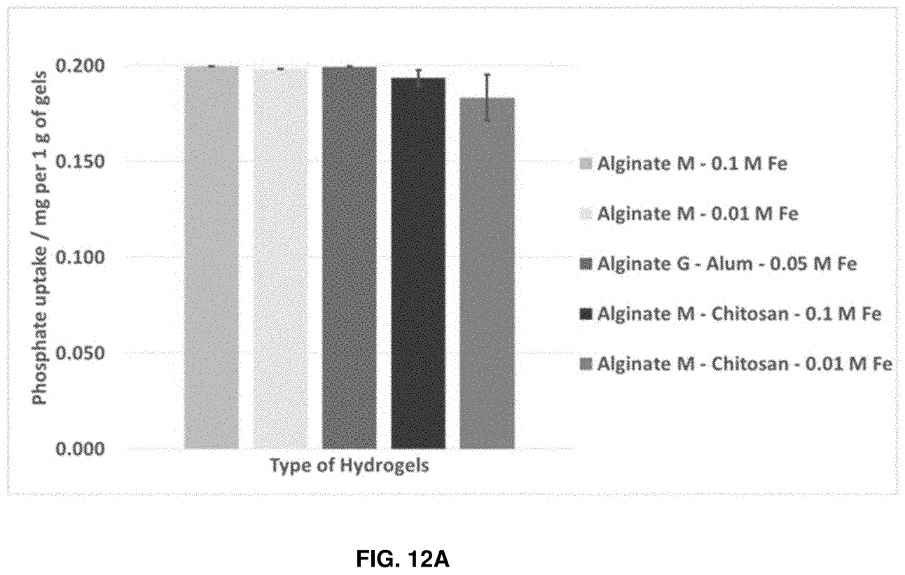

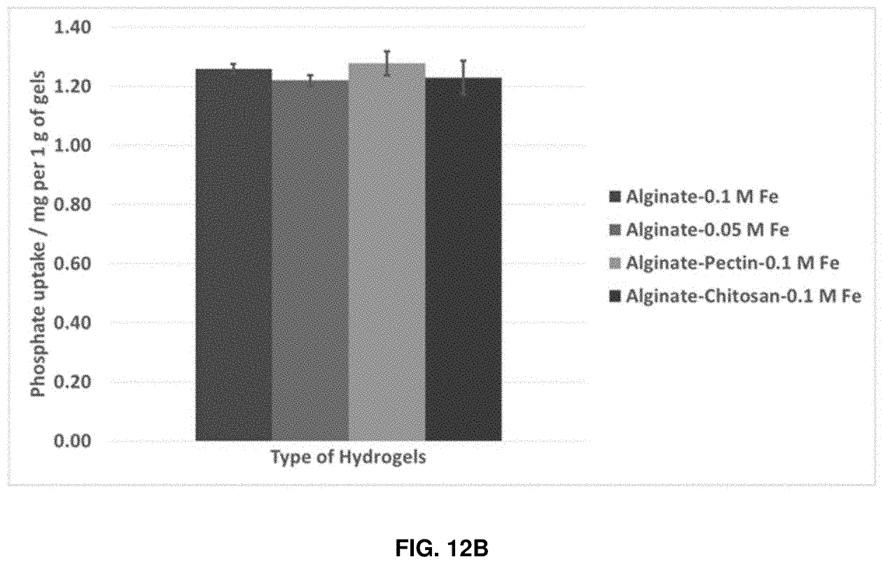

The phosphate uptake by the hydrogels depends on several factors, such as the identity of the polysaccharides, the concentration of the metal ion solution used to form the hydrogel beads, and the pH of the nutrient solution. (FIGS. 11-12.) Thus, the degree of loading can be customized as desired. In general, though, the hydrogel beads show good phosphate uptake, and some ammonium and nitrate uptake. Though the uptake of nutrients is described for example purposes, the hydrogel beads may be used to uptake other substances, and is not limited to being loaded with plant growth nutrients.

The nutrient ions can be released by exposing the loaded hydrogel beads to light. In the presence of light with sufficient energy, the hydrogel beads slowly degrade and release the plant nutrients that are encapsulated in a controlled manner. For example, a 2-10% release per day, depending on light conditions, may be generated. A slow release may be environmentally friendly and less expensive depending on the identity of the polysaccharide(s) in the hydrogel beads. Advantageously, the photorelease is tunable based on light and temperature. Furthermore, the action of microbes in a natural environment can degrade the hydrogel beads, thereby releasing any loaded nutrients, even in the absence of light. Thus, Fe(III)-carboxylate photochemistry can be utilized to produce a slow release fertilizer system for plants.

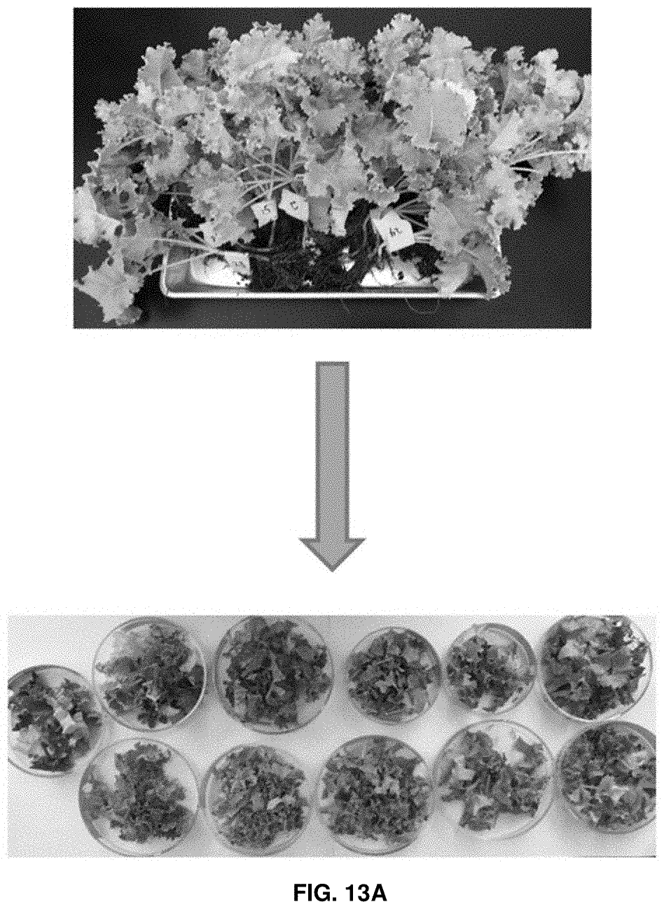

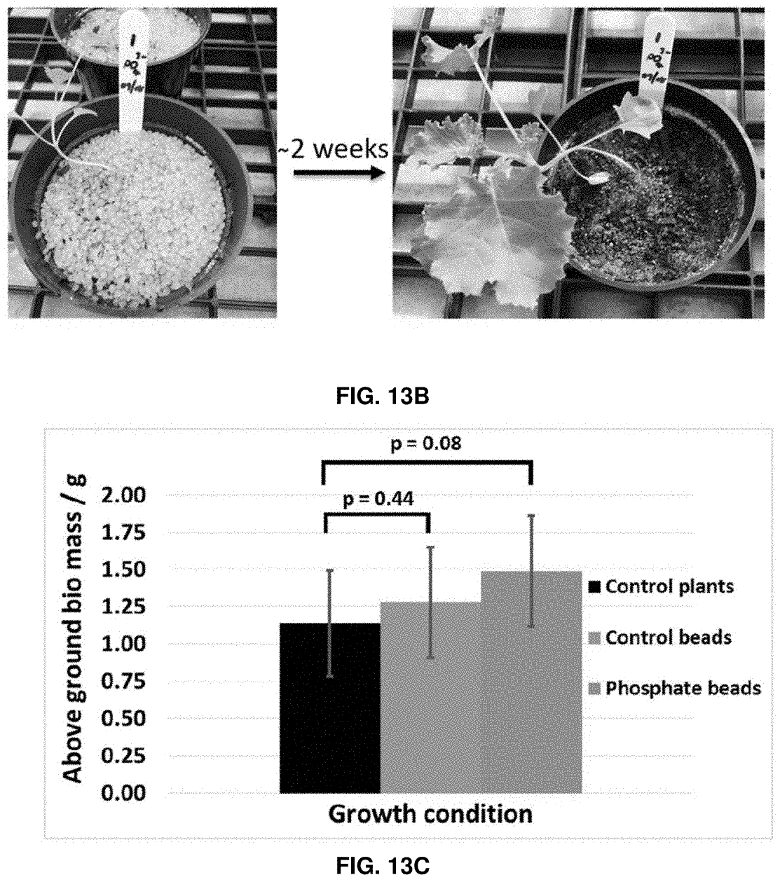

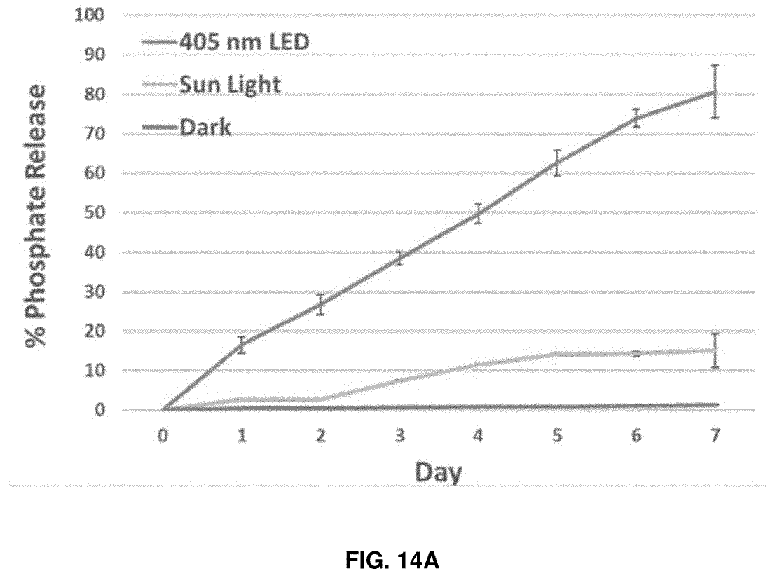

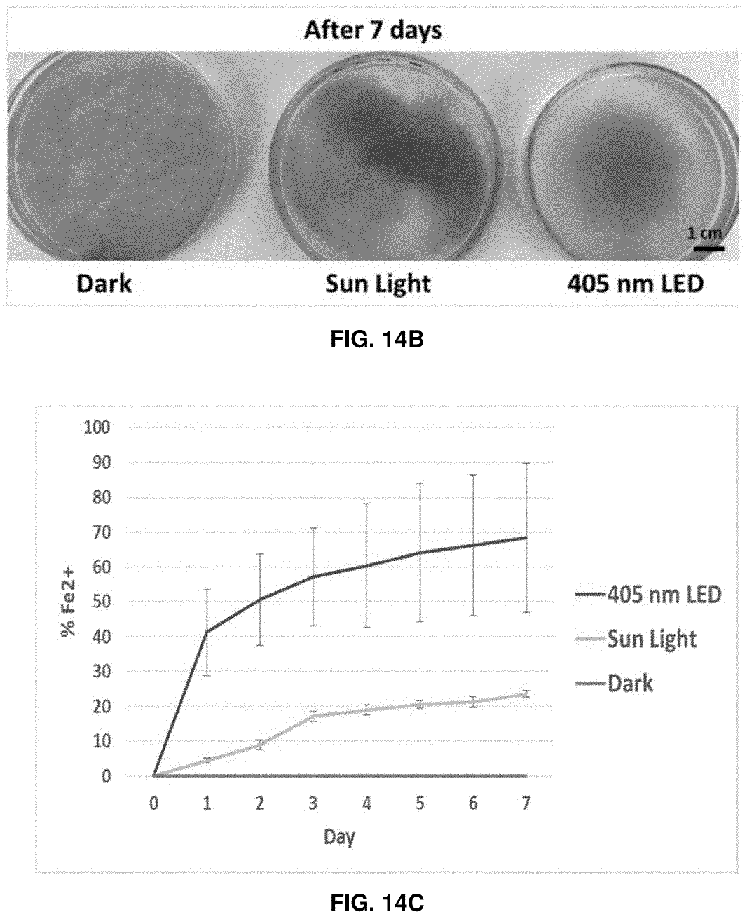

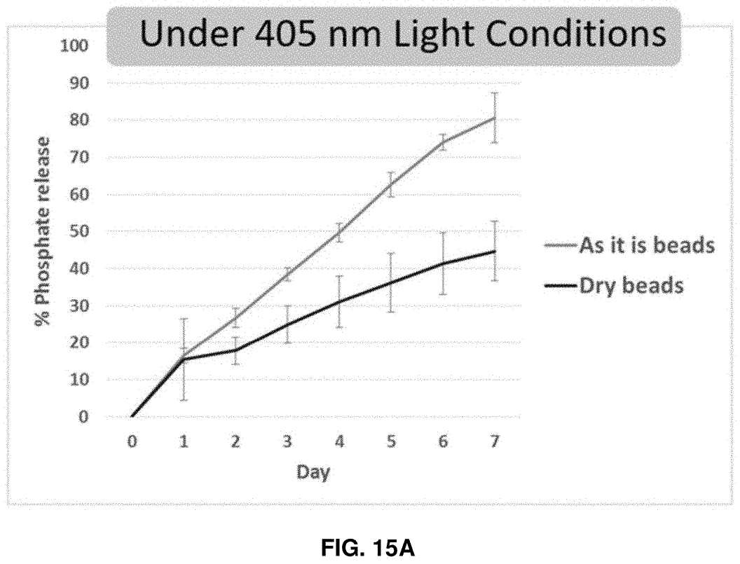

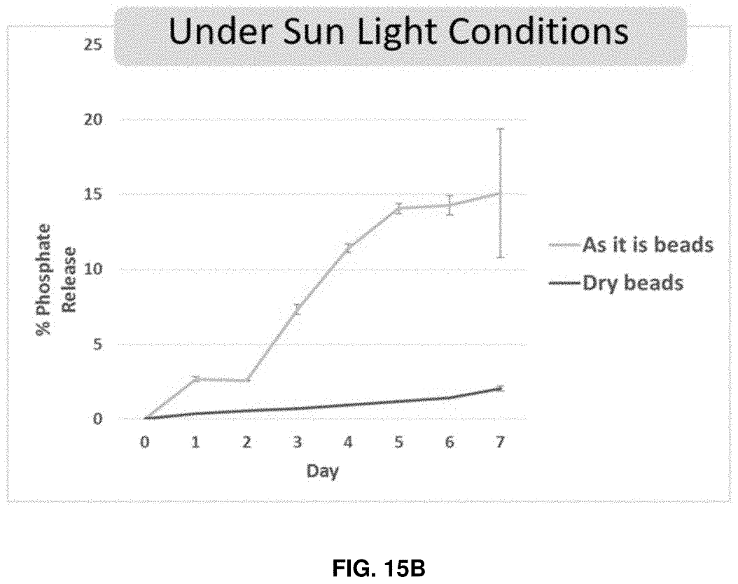

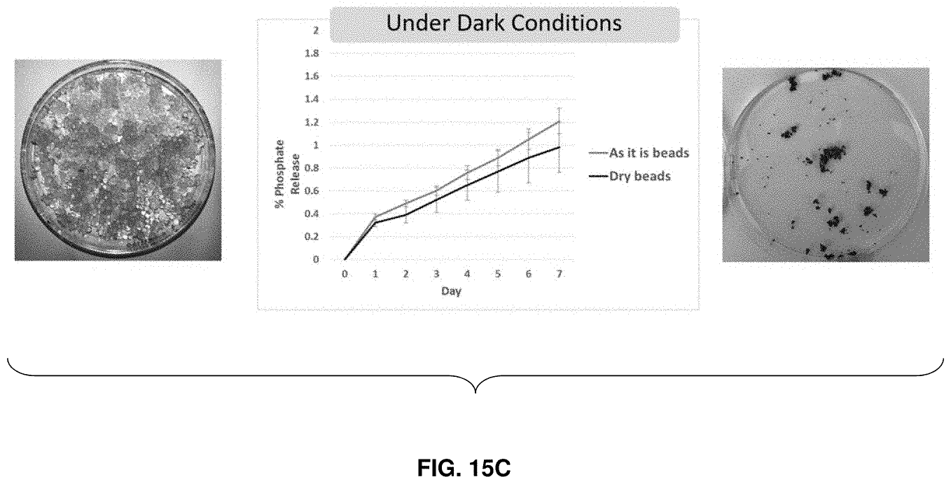

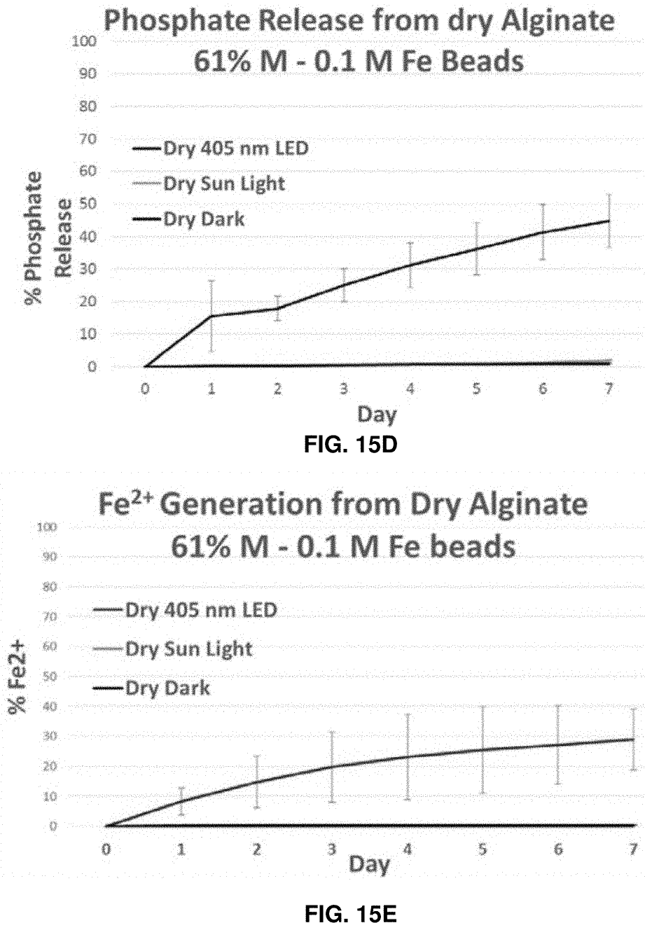

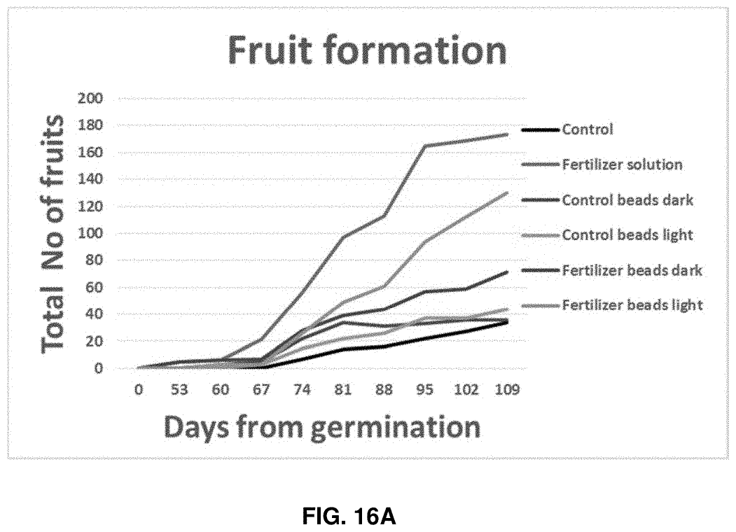

Many tests have been conducted on a variety of hydrogel beads, showing that they are capable of releasing nutrients upon exposure to light (FIGS. 14A-14C), they are non-toxic to plant seed germnination (FIGS. 13A-13B), they do not hinder plant growth, and they degrade after a few weeks of being planted outdoors (FIG. 13B). As seen, for example, from FIGS. 14A-14B, the generation of Fe²⁺ from such hydrogel beads correlates with the phosphate release. Thus, it is the photochemical reduction of Fe²⁺ to Fe²⁺ that allows for the major release of the phosphate. As seen from FIGS. 15A-15C, dehydration of the hydrogel beads slows down the phosphate release. Thus, the degradation rate of the hydrogel beads, and therefore the release rate of nutrients from the hydrogel beads, can be tailored as desired by hydrating or dehydrating the hydrogel beads accordingly.

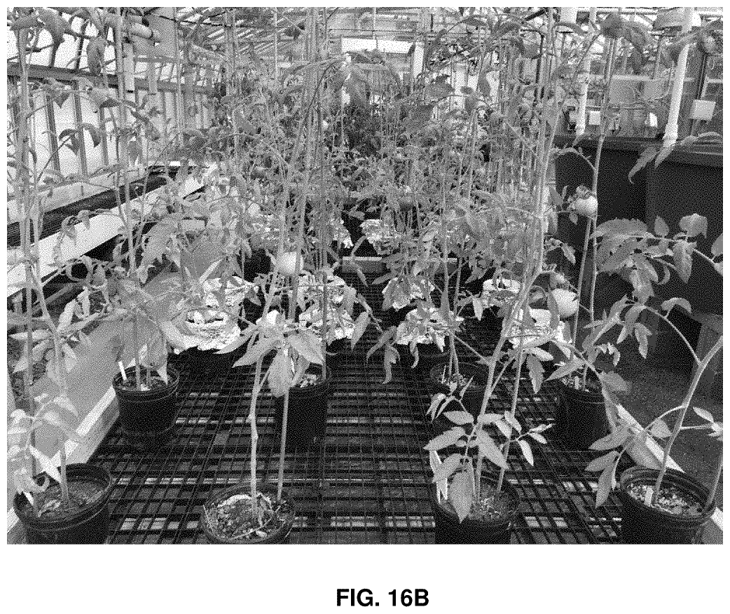

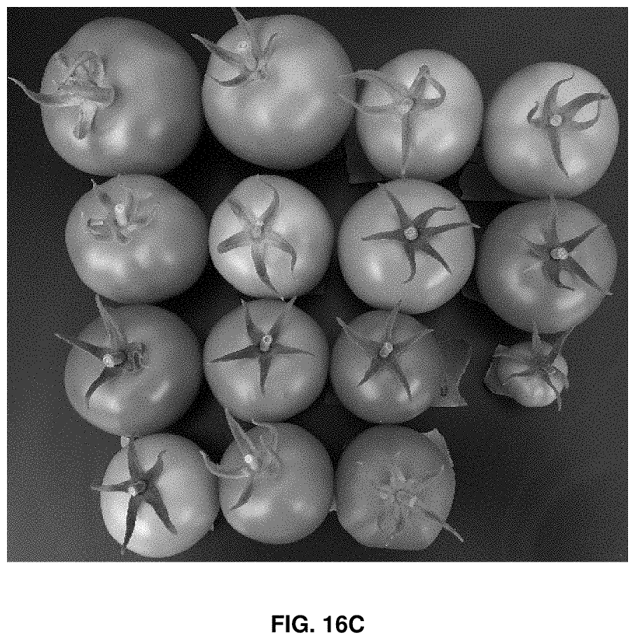

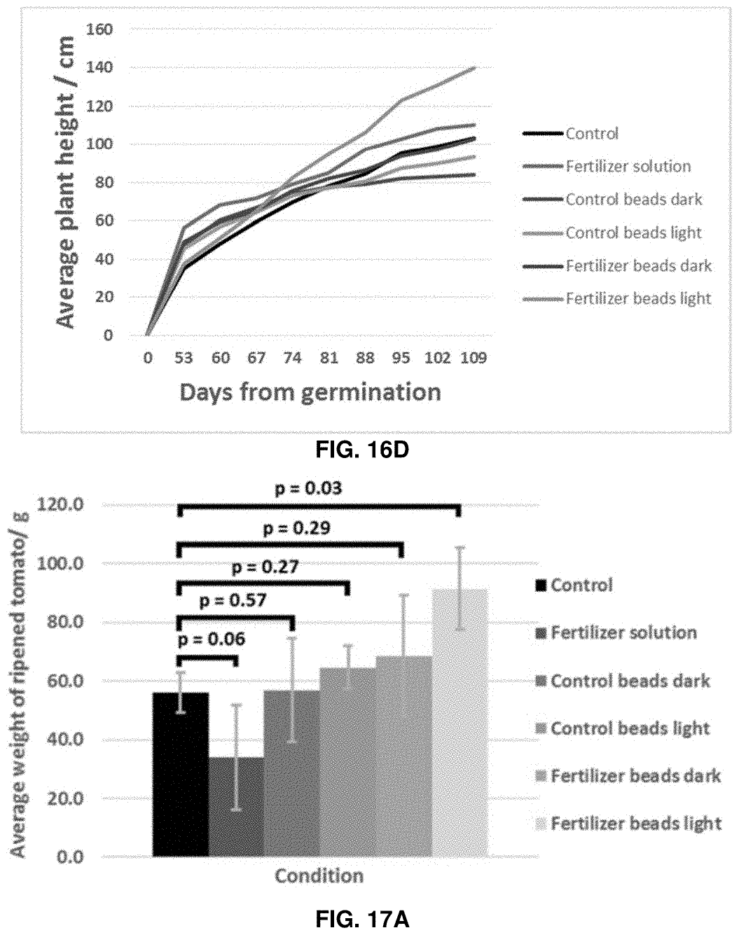

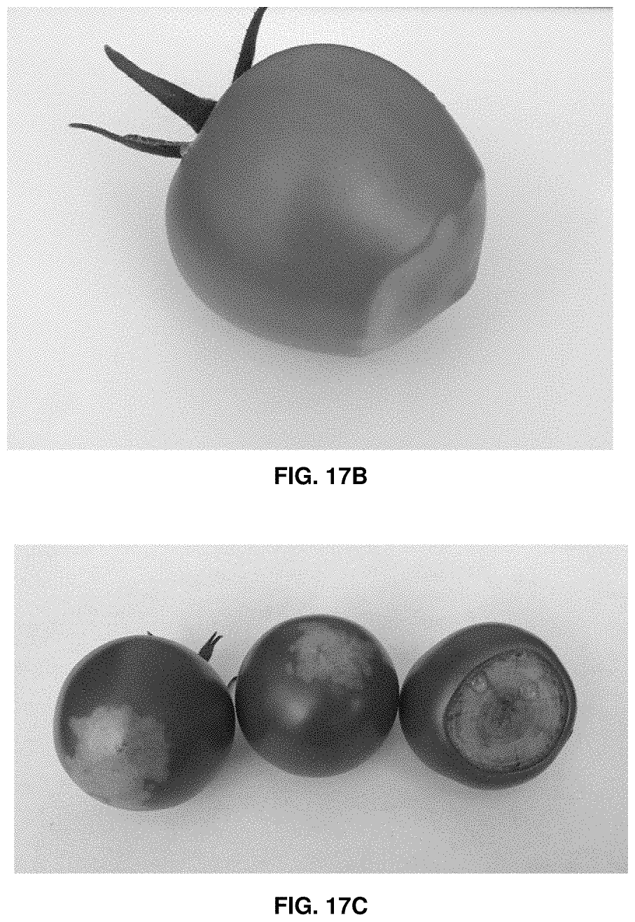

Tomato plant trials further demonstrated the success of the slow release fertilizer system. (FIGS. 16-17.) At least two ripened tomatoes were obtained from each condition. One-fifth of the tomatoes in plants treated with fertilizer solution ripened when they were small (weighed less than 10 g). In contrast, as shown in FIG. 17A, the average size of ripened tomatoes in plants treated with the fertilizer beads (i.e., loaded hydrogel beads) and exposed to light was the largest of the groups tested. Plants grown with the hydrogel bead fertilizer system produced fewer tomatoes, but larger tomatoes, compared to plants grown with conventional fertilizer. Furthermore, tomato plants treated with conventional fertilizer solution had blossom end rot, as seen in FIGS. 17B-17C, indicating the fruits were deficient in calcium and had an inconsistent water supply. Surprisingly, in contrast, blossom end rot was less common in the tomato plants treated with the slow release fertilizer system, indicating that the slow release fertilizer system improves water uptake by the plants. Without wishing to be bound by theory, it is believed that the fertilizer system helps retain water in the soil.

The fertilizer system described herein is non-toxic to plants, and capable of facilitating plant growth through the slow release of plant growth nutrients, and may have a limited environmental impact (for instance, to the agricultural fields where it is applied). Since the system is photoactive, the release of nutrients is controlled, which regulates waste, resulting in operating cost savings and environmental benefits. Furthermore, the preparation of the fertilizer system is quite simpler than the complex manufacturing/production processes required for some conventional slow release fertilizers. The present disclosure also addresses the problem of nutrient runoff by allowing for the encapsulation of plant nutrients in photo-active hydrogel beads so that nutrient loss by runoff and leaching is controlled.

However, the hydrogel beads described herein are not limited to use as fertilizer systems. Rather, the hydrogel beads described herein can be used in hygiene products, for oil water retention, in wound dressings, in drug delivery systems, in scaffolds for tissue engineering, in contact lenses, and so on. The hydrogel beads may also be useful in wastewater treatment plants, where waste water may be flowed through columns packed with the hydrogel beads to reclaim phosphates and other nutrients from the waste water. Thus, the hydrogel beads may also be useful for nutrient uptake applications without regard for their release of the nutrients.

It is further envisioned that the compositions and methods described herein can be embodied in the form of a kit or kits. A non-limiting example of such a kit is a kit for preparing a fertilizer system, the kit comprising polysaccharide-based hydrogel beads and a source of plant nutrients in separate containers, where the containers may or may not be present in a combined configuration. The source of plant nutrients may be, for example, in the form of a manure solution. Many other kits are possible, such as kits further comprising a plant seeds. The kits may further include instructions for using the components of the kit to practice the subject methods. The instructions for practicing the subject methods are generally recorded on a suitable recording medium. For example, the instructions may be present in the kits as a package insert or in the labeling of the container of the kit or components thereof. In other embodiments, the instructions are present as an electronic storage data file present on a suitable computer readable storage medium, such as a flash drive or CD-ROM. In other embodiments, the actual instructions are not present in the kit, but means for obtaining the instructions from a remote source, such as via the internet, are provided. An example of this embodiment is a kit that includes a web address where the instructions can be viewed and/or from which the instructions can be downloaded. As with the instructions, this means for obtaining the instructions is recorded on a suitable substrate.

### EXAMPLES

### Example 1—Reclaiming Phosphate from Waste Solutions with Fe(III)-Polysaccharide Hydrogel Beads for Photo-Controlled-Release Fertilizer

The present example uses natural polysaccharides and iron (III) for preparation of hydrogel beads. These hydrogels are more than 96% water and contain about 0.2% or less iron by weight. The hydrogel beads showed solution phosphate uptake capability ranging from 0.6-1.5 mgg⁻¹ for the pH range of 4.0-11.0 from 800 PPM phosphate solutions. Furthermore, these hydrogel beads showed above 99% phosphate uptake from 100 PPM phosphate solutions as well as about 1.2 mgg⁻¹ phosphate uptake from raw manure solutions. Upon the exposure of these hydrogels to light at wave lengths shorter than 450 nm, the photo chemical reaction between iron (III) and polysaccharide carboxylates slowly degrades the gel system. This process makes these hydrogels useful as a controlled release fertilizer system for phosphates and other nutrients. Experiments carried out under different light conditions show that phosphate release is dependent on exposure to light under natural sunlight and laboratory LED light conditions. Plant trials were performed with kale plants under greenhouse conditions and the hydrogel beads took about two weeks for complete degradation. Enhanced plant growth of kale plants with phosphate loaded hydrogels was seen visually as well from biomass analysis with no signs of iron toxicity, demonstrating the capability to recycle phosphates from waste water to agriculture fields.

Photo-responsive hydrogels from polysaccharides and Fe(III) were used as a system to capture and release PO₄³⁻ from waste solutions. The phosphate uptake capacity of different types of polysaccharide hydrogel beads at different pH values was evaluated. Kale plant trials were carried out with the phosphate loaded hydrogels to demonstrate the light-controlled phosphate release under natural conditions and the biodegradability of the fertilizer system under greenhouse environments.

Uptake of 0.6-1.5 mg phosphate per gram of hydrogels was determined from 800 ppm phosphate solutions (pH 4.0-11.0). These hydrogel beads also captured 1.2 mgg-1 phosophate from animal waste (raw manure, 727 ppm phosphate, pH 7.6), which accounted for above 80% phosphate uptake. Irradiation of phosphate-loaded hydrogels degraded the gels due to the photochemistry of the Fe(III)-carboxylates, giving controlled phosphate release (˜81% after 7 days). No release (<2% after 7 days) was seen in the dark. Kale plant trials showed complete degradation of the hydrogels in −2 weeks under greenhouse conditions. Biomass analysis of kale treated with phosphate-loaded beads compared to controls indicated no signs of toxicity. These results show Fe(III)-polysaccharide hydrogels were able to reclaim phosphates from waste solutions and can be used as a controlled release fertilizer system.

Materials and Methods

Materials

Sodium alginate 35% mannuronate (MW=97,000 Da) (Alginate G) and sodium alginate 61% mannuronate (MW=110,000 Da) (Alginate M) were received from Kimica Corporation. Alum (powdered) was purchased from a Kroger grocery store. Sodium phosphate (Na₃PO₄) anhydrous, disodium hydrogen phosphate (Na₂HPO₄) anhydrous, and sodium dihydrogen phosphate (NaH₂PO₄) anhydrous were purchased from Fischer scientific. Chitosan MW 50,000-190,000 Da (Lot STBH6262) was purchased from Aldrich chemical company. Pectin from citrus peel with 74% galacturonic acid (Lot SLBN9007V), Fe(III) chloride hexahydrate>98%, hydroxylamine hydro chloride 99%, 1,10 phenanthroline>99%, and sodium molybdate>98% were purchased from Sigma Aldrich. L-ascorbic acid>99% was purchased from J. T. Baker chemical company. Poly-D-galacturonic acid 95%, M_{w} 25,000-50,000 g/mol (Lot. 81325) was purchased from Sigma-Aldrich and prepared as the sodium salt by neutralization with NaOH. This material is re-ferred to as “pectate”. Hyaluronic acid sodium salt from Strep-tococcus equi, (Mw 1,500,000-1,800,000 g/mol) was purchased from either Sigma-Aldrich or Acros. Soluble potato starch and hydroxylamine hydrochloride were used as received from Mallinckrodt. Xanthan Gum (Mw 1,800,000-3,600,000) was purchased from Now Foods and used as received. Agarose was purchased from Life Technologies, Inc. and used as received. All the other chemicals were analytical reagent grade from Sigma-Aldrich or Fischer Scientific and all the aqueous solutions were prepared with de-ionized water. Raw manure solutions were obtained from a concentrated animal feeding operation for dairy cattle in Putnam County, Ohio. These raw manure solutions were mostly solution phase, with ˜3.3% as suspended solids. The manure solutions used for these experiments had an average pH of 7.6±0.1, and average phosphate, ammonium, and nitrate concentrations of 727 ppm, 1417 ppm, and <13 ppm (less than minimum detection limit), respectively, and were used as received without any additional treatment. Kale seeds (Dwarf blue curled vates) from Burpee (W. Atlee Burpee and Co.) and the Sungrow professional growing mix (Fafard 4 Mix Metro Mix 510) were used for the plant trials in this example.

Synthesis of Partially Oxidized Starch

Potato starch, 1 g, was suspended in 100 mL deionized water and gelatinized at 90-95° C. Next, the solution was cooled down to 20° C. before adding 10 mg TEMPO and 390 mg KBr. The pH was adjusted to 10.7 with 6 M NaOH. Then, the NaOCl solution (45 mL, 10-13% chlorine) was added drop wise in a 60 min period to the starch/TEMPO solution. While the hypochlorite was added, the pH was constantly measured and adjusted to 10.7 by the dropwise addition of 0.5 M NaOH. Finally, the solution was neutralized with HCl and the reaction quenched by adding 10 mL ethanol. The product was precipitated with methanol, centrifuged, and lyophilized. A degree of oxidation of 82% was calculated for the ratio of areas of the ¹H NMR peaks at 4.60 and 4.40 ppm, corresponding to the anomeric proton H—C(1) of glucuronic acid and anhydroglucose, respectively.

Hydrogel Bead Preparation

1% by weight aqueous polysaccharide solutions were used for hydrogel bead preparation. For the gel beads with two polysaccharides, the solutions were prepared with equal weights from each polysaccharide so that the total weight of polysaccharides in solution was still 1%. For the preparation of the alum beads, alum first was dissolved in water to obtain a 0.1% by weight alum solution. Then, the alginate 35% mannuronate (1% by solution weight) was slowly dissolved in the alum solution while vortexing to obtain the alum-alginate solution. These polysaccharide solutions were loaded in to syringes with a needle of 20 gauge, except for chitosan solutions, for which 18 gauge needles were used due to the larger particle size of chitosan. Hydrogel beads were obtained by dropping the polysaccharide solution into a petri dish filled with the FeCl₃ solution of desired concentration (0.1 M, 0.05 M, or 0.01 M) from a height of about 6 inches. Hydrogel beads were allowed to sit in the FeCl₃ solution for about 5 minutes for iron coordination, and then filtered. All the hydrogel beads were rinsed with DI water and allowed to air dry for 1 hour on top of paper towels (10-20% relative humidity) before weighing the required amounts for the experiments.

Scanning Electron Microscopy (SEM)

Hydrogel beads were cut into halves soon after freezing with liquid nitrogen, and lyophilized using Labconco Freeze dry system/Freezone 4.5 machine. Dried samples were sputter coated with Au/Pd using Hummer VI-A Sputter Coater for 2.5 minutes. SEM images were collected on a Hitachi 52700 scanning electron microscope at 12 kV. Energy dispersive x-ray spectroscopy (EDS) was performed using EDAX detecting unit (model: PV77-47700-ME) at a voltage of 20 kV.

Hydrogel Composition Analysis

For water content analysis, an exactly weighed sample of hydrogel beads was allowed to dry in an oven at 45° C. until constant weight was achieved. The final weight after the drying process was recorded and the water content was calculated based on weight loss on drying. For iron content analysis, an exactly weighed 10 g of samples of gel beads were photolyzed using a Thorlabs 405 nm light emitting diode (LED) source with a power of 5 Wcm⁻², and any remaining gel particles after 3 days were chopped with a mortar. The irradiated solution was transferred into a 100 mL volumetric flask and 1 ml of 10% hydroxyl ammonium chloride was added to convert any remaining Fe (III) to Fe (II) and diluted up to the mark. Quantification of Fe (II) was done by a colorimetric method where 0.1 ml of the diluted solution was added into a 10 ml volumetric flask which contained 2 ml of pH 4.02 acetate buffer. Then, a 1 ml liquate of 0.1% by weight 1,10-phenanthroline solution was added and diluted up to mark. The solution was allowed stand for 15 minutes for color development, and absorbance of the colored species was recorded at 510 nm, corresponding to a Fe (II) phenanthroline complex.

FTIR Spectroscopy

Freeze dried hydrogel samples were used for FTIR spectroscopy and a Jasco FTIR-4000 machine equipped with a single reflection ATR accessory was used for spectrum collection.

Phosphate Uptake from Artificial Waste Solutions

Hydrogel bead samples of 10 g were placed in 50 mL glass beakers with 20 mL solutions of desired phosphate solution (Na₃PO₄, Na₂HPO₄, NaH₂PO₄, or pH=7 phosphate buffer) with the phosphate concentration of either 800 ppm or 100 ppm PO₄³⁻. Beakers were covered with para films and placed on top of a Daigger 22407A mechanical shaker under dark conditions for 24 hours. Then, the gel beads were filtered off and the phosphate solutions were used for the remaining phosphate analysis.

For the experiments with 800 ppm phosphate solutions, the filtrates after the soak process were diluted by 100 times so that the final phosphate concentrations of the solutions were below 6 ppm PO₄³⁻. Colorimetric analysis was performed using a method designed by modifying the US Environmental Protection Agency (EPA) test method for orthophosphates using UV-Vis spectroscopy. A molybdate reagent was prepared by dissolving 1 g (4.86 mmol) of sodium molybdate in 40 ml of 3 M sulfuric acid, and 0.2 g of ascorbic acid was added to the solution. A 3 mL portion of this molybdate reagent was added to each test tube containing 20 ml of diluted phosphate solutions and they were covered with parafilm. The test tubes were placed in a hot water bath at 60° C. for 30 minutes and allowed to cool to room temperature before measuring their absorbance of the phosphomolybdate complex at 830 nm. Remaining phosphate concentrations were calculated using a calibration plot prepared for absorbance at 830 nm for phosphate solutions with 0.0-6.0 ppm phosphate concentration range. Phosphate uptake by the hydrogel beads was obtained by the difference of initial and final phosphate concentration of the solution.

All the 100 ppm PO₄³⁻ solutions were analyzed as-it-is without any dilutions since the remaining concentration of phosphate was low enough for the instruction. Remaining phosphate content was analyzed with the SEAL Analytical AQ2 Discrete Analyzer with a range of application from 0.005-1.0 mg P/L (0.015-3.0 ppm PO₄³⁻) using the US EPA test method 365.1.

Phosphate Uptake from Manure Solutions

Exactly weighed 10.0 g samples of hydrogel beads were placed in a 100 ml plastic cup and 20 ml of raw manure solution were added to them. The cups were allowed to stand for 24 hours and then the manure solution was separated from the beads. Remaining phosphate content in the manure solution was analyzed using the SEAL Analytical AQ2 Discrete Analyzer. Phosphate analysis of raw manure solution was also performed using the same instrument after a 50× dilution to bring the concentration in to the working range of the instrument.

Light Controlled Phosphate Release in Water

Samples of 10 g from alginate M-01 M FeCl₃ beads were soaked in 20 ml of 800 ppm phosphate solution (pH=7.0) for 24 hours. These beads were rinsed with DI water and placed in petri dishes with 20 ml of water and covered with a glass petri dish. The first set of samples was stored under dark conditions under room temperature and the second set of samples was placed on the roof in order to expose the samples to sunlight. The third set of samples was irradiated with the Thorlabs 405 nm LED light with an irradiance power of 50 mWcm² (measured with a S121C-Standard Photodiode Power Sensor, 400-1100 nm, 35.5 mW) and the laboratory temperature of 25° C. Aliquots of 6 mL were collected from each of these petri dishes every 24 hours for analysis, and 6 mL of DI water was added each time to maintain the same volume. The experiment was continued for 7 days and the solutions were diluted appropriately and analyzed for phosphate content using the same colorimetric molybdate method used for the phosphate uptake experiments. Iron (II) content in each of these solutions was also analyzed using the same 1,10-phenanthroline method which was used before in the hydrogel composition analysis.

Plant Trials

Kale seed germination studies were carried out under greenhouse conditions in small pots filled with 5 g of Sungrow professional growing mix 510 and dwarf blue curled vate kale seeds (Brassica oleracea) were placed about 1 cm below from the surface. Three different conditions were provided for the seeds with 8 pots under each condition. For the first condition, each pot was treated with 5 g of Alginate G-0.1% alum hydrogels that were soaked in a 800 ppm phosphate solution (pH=7) for 24 hours. Portions of 5 g of hydrogel beads without soaking in phosphate solution were used as the second condition, and the third condition was pots with no hydrogel beads added. All the pots were watered with equal amounts of DI water three times every week and the experiment was carried out for three weeks.

To access the effects of the hydrogel beads on growth after germination, kale plant trials were also conducted under greenhouse conditions. Kale plants that were 17 days old (from day of seed planting) were transplanted in plastic pots (8.5 cm×10 cm diameter) filled with 100 g of Sungrow professional growing mix 510. A thin layer of water-washed and dried sand (75 g) was added to hold the hydrogel beads on the top of the pot upon watering. Similar to the seed germination experiments, three conditions were provided for the plants, namely, 10 g of phosphate loaded alginate 53% M-0.1% alum beads, 10 g of control beads (no nutrient loading), and control with no beads. 8 replicates were performed under each condition. Plants were watered three times every week with 100 mL of DI water. After three weeks, another set of hydrogel beads was added for the hydrogel bead conditions. By the end of the sixth week from transplanting, kale plants were harvested and the root systems were separated from the plants. All the parts of the plants except the root system were cut into pieces and weighed. Then, they were oven dried at 45° C. until a constant weight was obtained and above ground bio mass was determined.

Results and Discussion

Phosphate Uptake from Hydrogel Beads

The uptake of phosphate by beads prepared with different types of alignates, and with different concentrations of Fe(III), was evaluated. The beads were first prepared as described above. The beads were spherical and approximately 3-4 mm in diameter with an orange color, indicative of Fe(III). (FIG. 4A-4B.) Alginate hydrogel bead formation was a quick process because of the fast coordination of iron (III) to the alginate carboxylate groups. These beads started to appear in the iron (III) chloride solution as transparent beads within seconds after dropping, and developed their color to more intense orange color with further coordination of Fe²⁺ ions. Once prepared, the Fe(III)-alginate beads were soaked in phosphate solution of different concentrations, and the amount of phosphate that remained in the beads was determined. Hydrogel beads were prepared under a variety of different conditions to investigate the effects of Fe(III) concentration, the structure of the polysaccharide, and pH on the overall uptake of phosphate into the hydrogels.

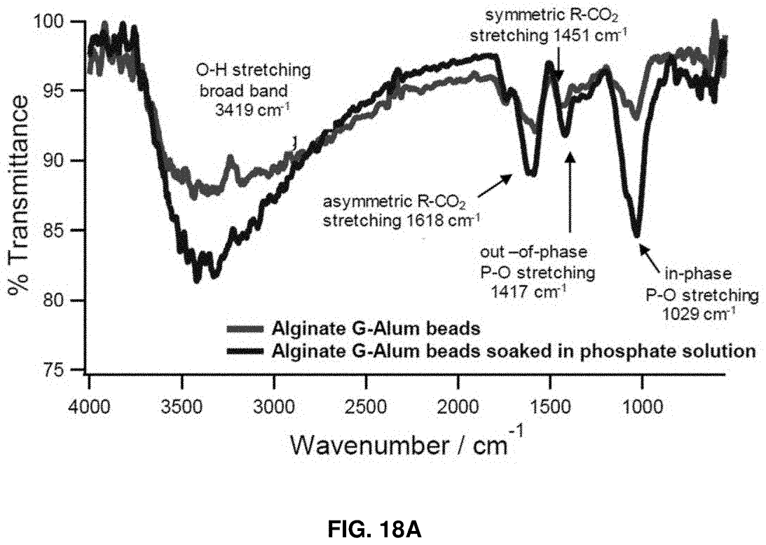

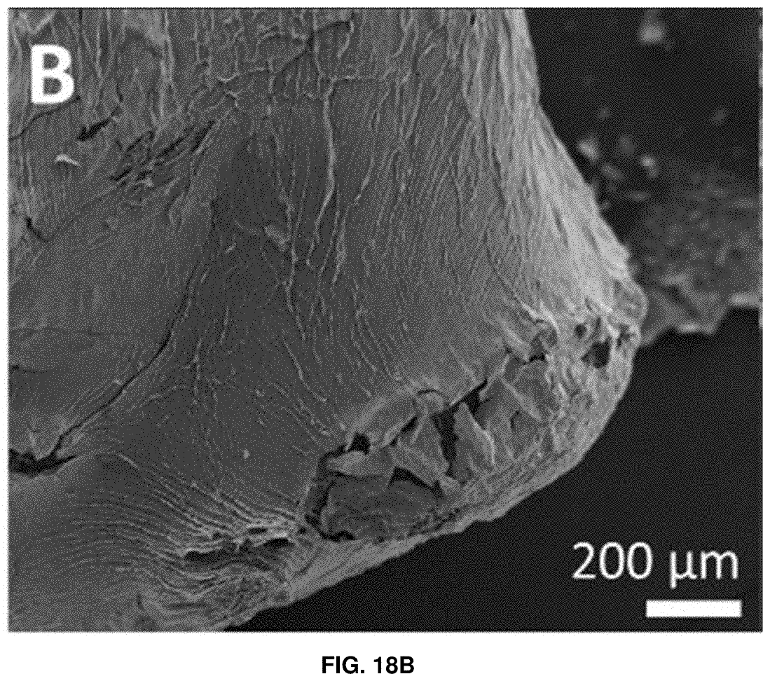

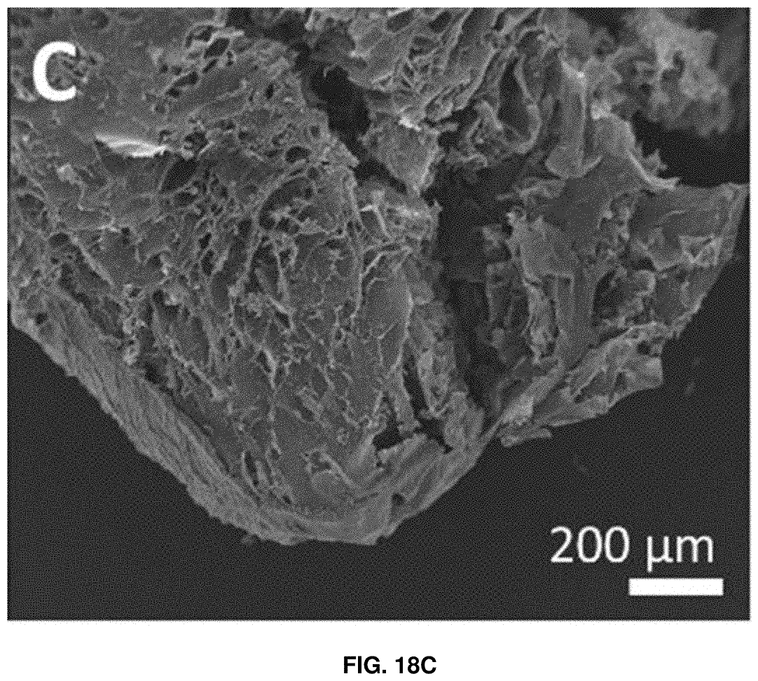

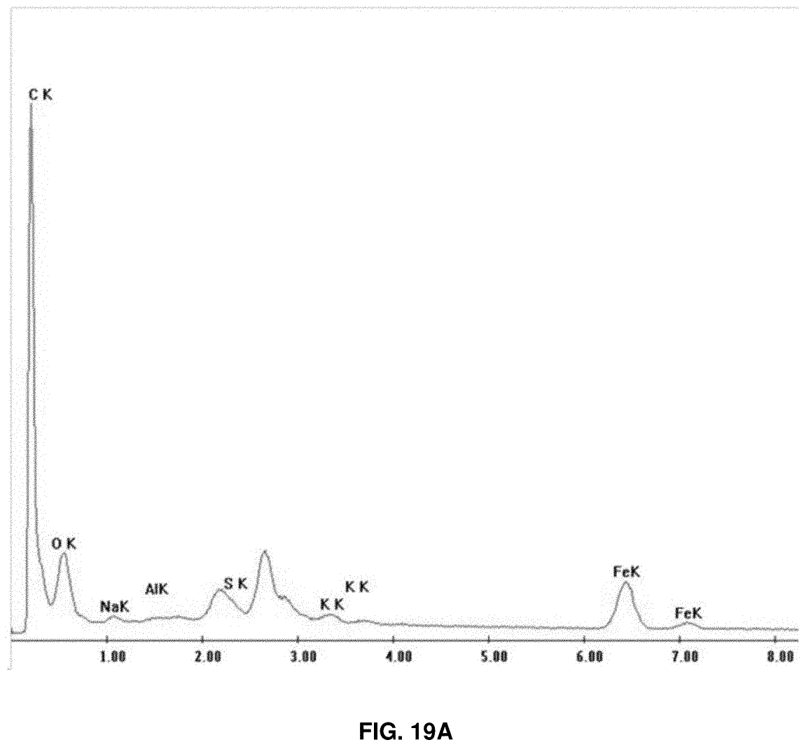

The FT-IR spectrum of Alginate G-Alum-0.05 M Fe beads (FIG. 18A) clearly shows characteristic peaks for O—H stretching (broad band centered around 3400 cm⁻¹), asymmetric stretching of CO₂₋ (intense peak around 1600 cm⁻¹), symmetric stretching of the R—CO₂₋ (peak around 1400 cm⁻¹), and asymmetric C—O—C stretching (around 1100 cm⁻¹). After soaking in phosphate solutions, clear differences were seen at 1080 cm⁻¹, 1650 cm⁻¹, and 3300 cm of the FTIR spectra (FIG. 18A). The most intense peak around 1080 cm⁻¹ was attributed to the in-phase P—O stretching frequency of the PO₄³⁻ group. Studies on FTIR spectra of phosphate ions have shown that phosphates have a medium peak around 1650 cm⁻¹ and a very strong, broad peak in the 3200 cm⁻¹ region. An increased IR absorbance was seen in these regions for the hydrogels, which were soaked in PO₄³⁻. Therefore, these observations in the FTIR spectra of hydrogels soaked in phosphate solution indicated that the phosphates ions were trapped inside the hydrogels during the soaking process.

Scanning Electron Microscope imaging of gel beads showed that the surface of the hydrogel beads have a crust-like structure with mostly smooth areas. (FIG. 18B.) In contrast, the interior of the hydrogel bead is more porous in nature (FIG. 18C) with interconnected channels to facilitate the large amount of water present in the hydrogel system.

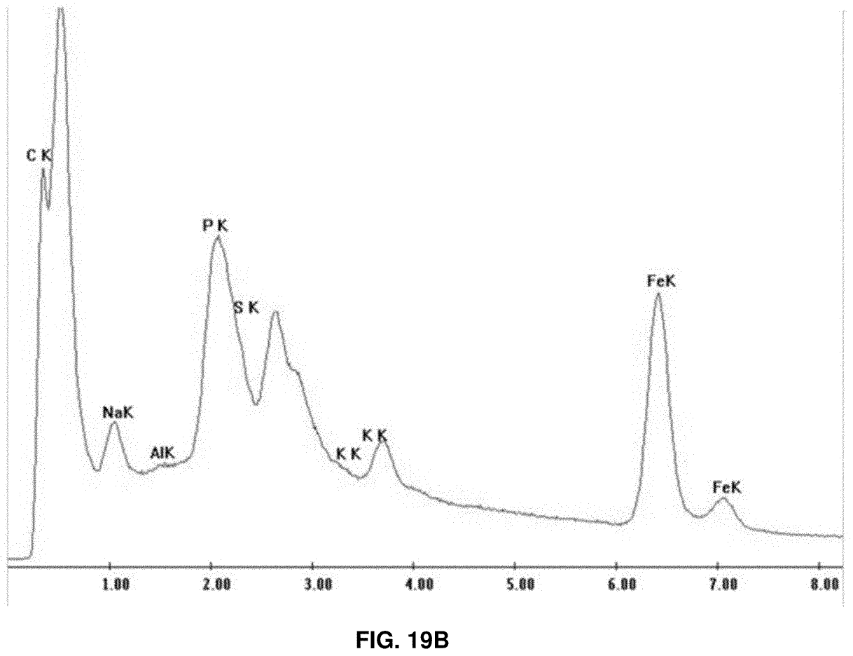

Quantitative elemental analysis was performed for the hydrogel beads using Energy Dispersive X-ray Spectroscopy (EDS) before and after soaking in the phosphate solution (FIGS. 19A-19B). It is important to note that the percent weight of each element was calculated excluding the gold and palladium which were used to coat the samples before the experiment (Au and Pd appear at 2.12 and 2.84 in EDS spectra, respectively). EDS confirmed the presence of phosphorus in the hydrogel system after the soak time, which was not seen in the hydrogel beads before soaking in phosphate (Table 1). Phosphorus was present more than 5% by weight in the hydrogels after the soaking process. Also upon the soaking process, oxygen became the most abundant element in the system due to the additional oxygen atoms from PO₄³⁻.

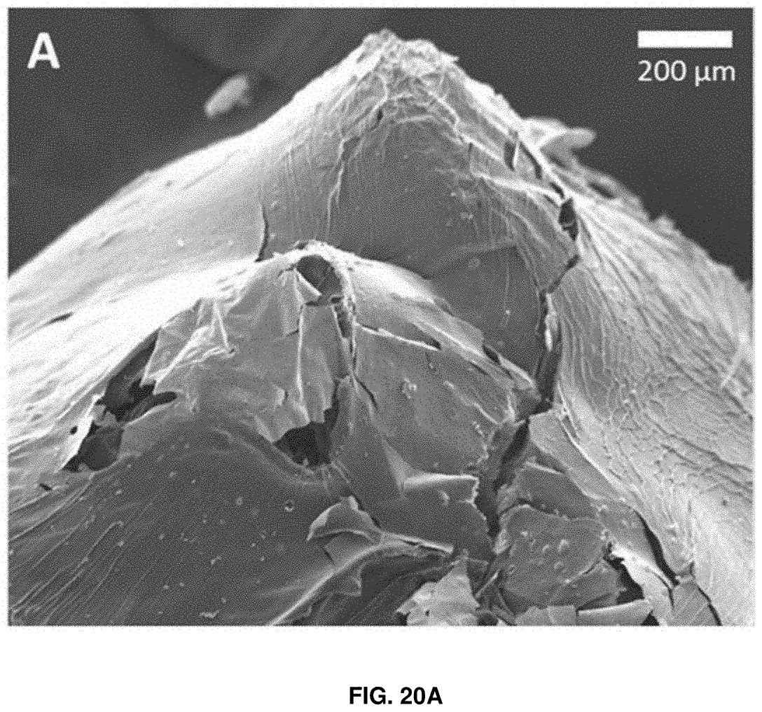

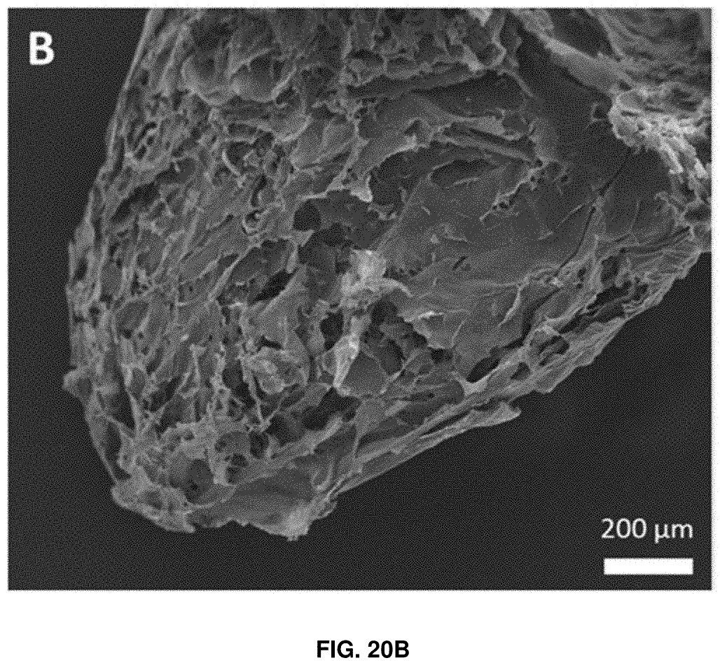

Another interesting feature was that the EDS elemental analysis performed for the phosphate-soaked gel bead exterior showed differences in the element percentages compared to the interior (Table S1). Higher carbon percentage in the gel exterior along with higher iron, oxygen, and phosphorus percentages in the gel interior may be due to the slight rearrangements of the dynamic hydrogel structure during the soaking in phosphate solution. Without wishing to be bound by theory, it is believed that to facilitate the negatively charged phosphate groups within the hydrogel system, positively charged Fe(III) ions tended to move towards interior of the dynamic hydrogel structure along with the carboxylate groups that they were coordinated to. This exposed the carbon polysaccharide chain to the hydrogel surface which caused the higher carbon content in the gel exterior compared to the interior. SEM images of hydrogels soaked in phosphate solution (FIGS. 20A-20B) did not show any significant differences compared to the SEM images of hydrogel beads before soaking (FIGS. 18B-18C).

It was believed that the phosphate uptake by the hydrogels would be largely controlled by the charge and Fe(III)-coordination in the hydrogels. To investigate the differences, phosphate uptake was determined from several kinds of polysaccharide hydrogels with different Fe(III) concentrations. All the different types of hydrogel beads showed phosphate uptake behavior of 1 mg per 1 g of hydrogel beads or more at pH 7 with the 800 ppm phosphate solution (FIGS. 11A-11D). Regardless of the polysaccharide composition, hydrogel beads prepared with 0.1 M FeCl₃ solution showed a phosphate uptake of 1.2 mg of phosphate per 1 g of hydrogels or more at pH=7 (FIG. 11A). The slight changes of phosphate uptake with the change of the polysaccharide composition was statistically insignificant at 95% confidence interval (p=0.20, 0.12, and 0.14 for alginate G-0.1 M Fe(III) beads compared to alginate M-0.1 M Fe, alginate G-pectin-0.1 M Fe(III), and alginate G-chitosan-0.1 M Fe(III), respectively). Also, it was noted that the effect of the concentration of Fe(III) solution used for the hydrogel bead preparation on the phosphate uptake behavior (FIG. 12B) was also statistically insignificant at 95% confidence interval for the three Fe(III) concentrations used (0.01, 0.05, and 0.1 M). All the hydrogel beads prepared with the 0.1 M FeCl₃ solution had slightly higher phosphate uptake and stability over a wider pH range than the beads prepared with 0.01 M FeCl₃ solution (FIGS. 11D-11E). This may be because beads prepared with 0.1 M FeCl₃ solution showed more Fe inside the beads than the beads prepared with the more diluted solution (Table 2), indicating that Fe(III) was definitely playing a role in phosphate uptake.

All the different types of hydrogel beads showed phosphate uptake behavior of 1 mg per 1 g of hydrogel beads or more at pH 7 with the 800 ppm phosphate solution (FIGS. 11A-11D). Regardless of the polysaccharide composition, the hydrogel beads prepared with 0.1 M Iron (III) chloride solution showed a phosphate uptake of 1.2 mg of phosphate per 1 g of gels or more. (FIG. 11A.) Also, it was noted that the concentration of iron (III) chloride solution used for the hydrogel bead preparation affected towards the phosphate uptake behavior (FIGS. 11B, 11D). All the hydrogel beads prepared with the 0.1 M iron (III) chloride solution had higher phosphate uptake than the beads prepared with 0.01 M iron (III) chloride solution. Without wishing to be bound by theory, this is believed to be because beads prepared with 0.1 M iron (III) chloride solution have more Fe inside the beads than the beads prepared with the more diluted solution (Table 1), indicating that iron is playing a role in phosphate uptake.

In the case of alginate G beads, the beads prepared with 0.05 M iron (III) chloride solution showed good phosphate uptake quite similar to the 0.1 M iron beads. (FIG. 11B.) This indicates that even 0.05 M concentration of iron is sufficient for preparation of gels with good phosphate uptake. It is known that phosphates can bind strongly to iron and aluminum oxy-hydroxides and play an important role in nature as efficient carriers of phosphates.

The results of compositional analysis carried out for hydrogel beads are listed in Table 1. Water is the major constituent in the hydrogel beads with more than 96% for the analyzed type of beads. Iron content in the beads was around 0.2% or less all the time, and the rest of the composition was mostly the polysaccharide. Interestingly, the alum beads had a higher iron content than alginate G-0.05 M Fe beads, with added alum being the only difference in hydrogel bead preparation.

When considering the alginate M beads prepared with iron (III) chloride solutions with different concentrations, it is seen that the total iron content was lowest for the beads prepared with 0.01 M iron (III) chloride solution, and the maximum iron content was seen for the beads prepared with the intermediate iron (III) chloride concentration of 0.05 M. Surprisingly, the beads prepared with the 0.1 M iron (III) chloride solution had slightly lesser total iron content than the beads prepared with the 0.05 M iron (III) chloride solution. The alginate-Fe beads have different types of iron species such as iron nanoparticles, hydroxo-/carboxylate-bridged dimers, and high spin octahedral Ferric irons. These changes of total iron content observed may be due to the presence of different iron species within the hydrogel systems prepared with different iron (III) chloride solutions in different ratios. In this example, only total iron content (i.e., not the exact iron species) was evaluated to see whether it relates to increased phosphate uptake by different kinds of hydrogel beads.

Composition analysis was carried out for hydrogel beads to study their differences (Table 1). Water was the major constituent in all the hydrogel beads accounting for more than 96% by weight for types of beads that were analyzed. Total Fe(III) content by weight in the beads was 0.2% or less. The rest of the bead composition was the polysaccharide. Interestingly, the hybrid Fe/alum beads showed higher Fe(III) content than analogous beads made with only FeCl₃. This may be due to the presence of Al(III) ions, resulting in some mixed Fe(III)/Al(III) moieties inside the beads that contributed to a higher overall metal content.

TABLE 1
Composition analysis of hydrogel beads as prepared

| | | | % Others |
|---|---|---|---|
| Gel bead type | % Water | % Iron | (by difference) |
| Alginate G -Alum- | 96.17 ± 0.08 | 0.21 ± 0.01 | 3.62 |
| 0.05M Fe | | | |
| Alginate G - | 97.09 ± 0.01 | 0.17 ± 0.08 | 2.74 |
| 0.05M Fe | | | |
| Alginate M - | 98.07 ± 0.14 | 0.16 ± 0.02 | 1.77 |
| 0.1M Fe | | | |
| Alginate M - | 97.16 ± 0.04 | 0.23 ± 0.04 | 2.61 |
| 0.05M Fe | | | |
| Alginate M - | 98.27 ± 0.05 | 0.04 ± 0.01 | 1.69 |
| 0.01M Fe | | | |

In the case of Alginate G beads, the beads prepared with 0.05 M Fe(III) solution showed good phosphate uptake quite similar to the beads prepared with 0.1 M Fe(III) (FIG. 11B). Even the phosphate uptake from beads prepared with 0.01 M Fe(III) was not significantly different from the uptake from 0.1 M Fe(III) beads at pH 7. When considering the Alginate G beads prepared with FeCl₃ solutions with different concentrations, the total iron content was observed to be the lowest for the beads prepared with 0.01 M Fe(III) solution, and the maximum iron content was seen for the beads prepared with the intermediate Fe(III) concentration of 0.05 M (Table 2). While the beads prepared with the 0.1 M FeCl₃ solution had slightly less total iron content than in the beads prepared with the 0.05 M FeCl₃ solution, this difference is not statistically significant at 95% confidence interval (p=0.09). This follows the observations seen in the phosphate uptake experiment where beads prepared with 0.1 M FeCl₃ absorbed slightly less phosphate than beads prepared with 0.05 M FeCl₃ solution. Again, this indicates a role for Fe(III) in the binding of phosphates within the hydrogels.

These changes of total Fe content that were observed may be due to the presence of different Fe species within the hydrogel systems prepared with different FeCl₃ solutions in different ratios. In this example, the exact iron species was not investigated, and only total iron content was studied to see whether it relates to phosphate uptake by different kinds of gel beads.

The phosphate uptake process was mostly independent from the pH for almost all the hydrogels prepared with high Fe(III) concentrations. For the gels prepared with lower FeCl₃, the phosphate uptake was decreased with increasing pH. (FIGS. 11D-11E.) In addition, the Fe(III)-polysaccharide hydrogels showed some instability (especially the beads prepared with 0.01 M FeCl₃ solutions) after the soak time of the experiments with pH=11.5 Na₃PO₄ solution. Some of the gel beads dissolved in the highly basic solution, turning the solution orange color due to Fe(III) from the bead dissolution and dispersal into the bulk solution of Fe(III) species. This dissolution of the gel beads at high pH resulted in less overall amount of gel beads for phosphate uptake, and this may account for the relatively lower phosphate uptake values.

To access the effect of initial phosphate concentration, similar experiments were carried out with the lower concentration of 100 ppm phosphate solution (pH=7), and they showed 99% of phosphate uptake from the solutions (FIG. 9A). In the lower concentration of phosphate solution, the hydrogel beads absorbed phosphates at about 0.2 mg of PO₄³⁻ per 1 g of gel beads, which was about ⅕^{th} of the maximum phosphate uptake capability. Once again the changes of phosphate uptake capability with the change of hydrogel type was not statistically significant at the 95% confidence interval. The low phosphate concentration in solution did not allow the beads to uptake phosphate at their maximum efficiency. But all types of gel beads tested were affected similarly regarding their binding of phosphate.

The phosphate uptake process, which is a pH-dependent process with relatively low phosphate uptake, was recorded for the 800 ppm Na₃PO₄ solution which had a pH value of 11.5. (FIG. 11D.) After the soak time of the experiments carried out with this pH=11.5 Na₃PO₄ solution, it was observed that some of the hydrogel beads dissolved in the highly basic solution, turning the solution into an orange color due to Fe (III) in it. This instability of some of the hydrogel beads at high pH solution results in having a lesser amount of hydrogel beads for phosphate uptake, and may be a reason for the relatively lower phosphate uptake values.

Similar experiments carried out with the 100 ppm phosphate solution (pH=7) showed 99% of phosphate uptake from the solutions. (FIG. 12A.) The low concentration of phosphate solution makes the hydrogel beads absorb phosphates at about 0.2 mg of PO₄³⁻ per 1 g of gel beads, which is about a fifth of their maximum phosphate uptake capability. Unlike the experiment with 800 ppm phosphate solution, here a difference in phosphate uptake based on the polysaccharide ratio or the concentration of iron (III) chloride used for gel bead preparation was not seen. This is again because the low phosphate concentration in solution does not require the beads to uptake phosphate at their maximum efficiency.

Animal waste solutions were used as the next step to evaluate the phosphate uptake capability of these Fe(III)-polysaccharide beads in this multi-component system. Phosphate uptake experiments carried out with dairy liquid animal waste solution (with a phosphate concentration of 727 ppm and a pH of 7.6±0.1) also showed relatively good phosphate absorption behavior by the gels (FIGS. 9B, 12B). Similar to the phosphate uptake experiments with the 800 ppm phosphate solutions (pH=7.0), the phosphate uptake values were around 1.2 mgg⁻¹.

The manure solution used for these experiments had an initial phosphate content of 727 ppm phosphate and a pH of 7.6±0.1. The hydrogel beads showed their maximum phosphate uptake behavior similar to the artificial phosphate waste solutions with 800 ppm phosphate. Even though manure was a mixture of some other ions such as ammonium and nitrates and various suspended solids, these did not significantly affect the phosphate uptake behavior of the gel beads.

The ability to uptake phosphate from solutions makes these hydrogels suitable for recycling phosphorus. The photochemical reaction between Fe(III) and carboxylate groups breaks the polymer chain and eventually the hydrogel network, hence phosphate can be released by using light. Phosphate loaded hydrogel beads showed very low phosphate release under dark conditions (FIG. 14A and Table 2). After 7 days, the total phosphate release was less than 1.5% and the hydrogel beads did not show any change in appearance (FIGS. 14A-14B). The samples exposed to sunlight showed a 15% phosphate release over 7 days, some of the hydrogel beads degraded and the remaining gel particles were due to the incomplete photoreaction. The samples irradiated with 405 nm light (50 mWcm²) showed the highest phosphate release with greater than 80% of phosphate release after 7 days. Also, the remaining hydrogel particles were less than the sunlight samples (FIG. 14B). This significant difference in sunlight and 405 nm conditions was attributed to lower intensity of light that would initiate the photoreaction.

TABLE 2
Average phosphate release from alginate 61% M - 0.1M
FeCl₃ beads in water under different light conditions
after three trials from each condition.

| | Average cumulative phosphate release (ppm) | | |
|---|---|---|---|
| Day | Dark | Sunlight | 405 nm LED |
| Day 1 | 0.049 ± 0.004 | 0.349 ± 0.024 | 2.1 ± 0.2 |
| Day 2 | 0.064 ± 0.004 | 0.337 ± 0.005 | 3.5 ± 0.3 |
| Day 3 | 0.079 ± 0.006 | 0.960 ± 0.041 | 5.1 ± 0.2 |
| Day 4 | 0.099 ± 0.008 | 1.494 ± 0.035 | 6.5 ± 0.3 |
| Day 5 | 0.117 ± 0.009 | 1.842 ± 0.044 | 8.2 ± 0.4 |
| Day 6 | 0.14 ± 0.01 | 1.86 ± 0.09 | 9.7 ± 0.3 |
| Day 7 | 0.16 ± 0.01 | 2.0 ± 0.6 | 10.6 ± 0.9 |

The solar irradiation consisting of wavelengths from ultra-violet to infra-red was less intense than the narrow-band 405 nm LED used in the lab. Additionally, the sunlight conditions were only irradiated for about 14 hours per day (during fall) whereas the samples irradiated with the 405 nm light source in the lab were exposed to the light for 24 hours per day. The temperature of the LED experiment varied less in the lab than outdoors during day and night, and the average outdoor temperature was lower than the lab, and that may also affect the phosphate release. The overall photochemical reaction yield was determined by quantifying the Fe(II) generated during light irradiation. This trend in Fe(II) production followed the phosphate release trend, showing that the Fe(III)-carboxylate photochemical reaction degraded the hydrogel to generate Fe(II) and released the trapped phosphate ions from the hydrogels.

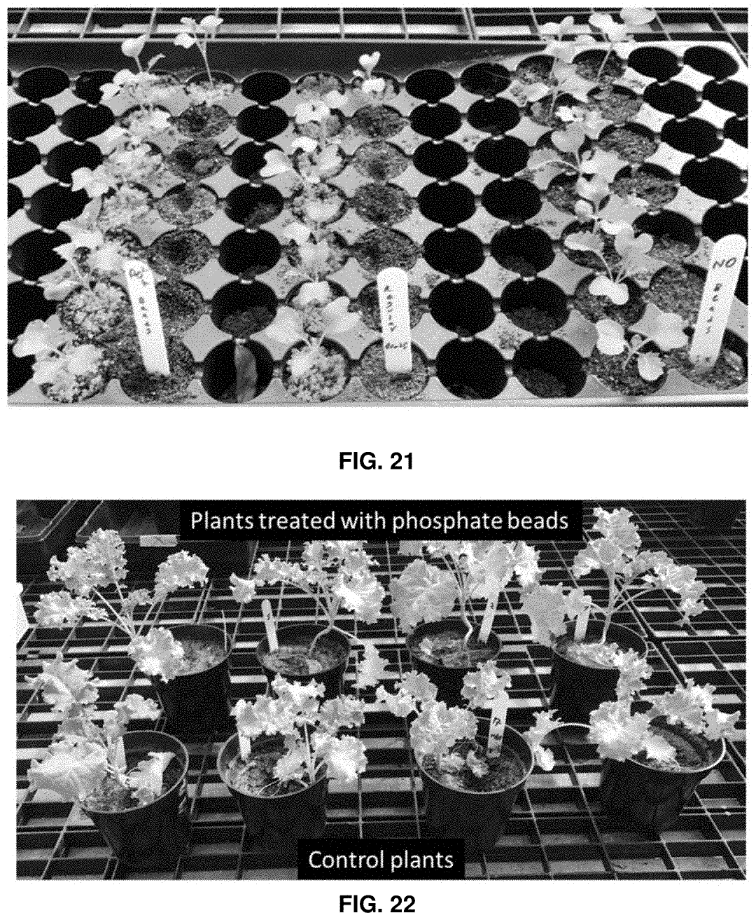

To investigate the application of these hydrogels as a solid fertilizer, plant trials on kale were performed in a green house. Seed germination experiments were carried out with kale seeds to assess the toxicity of the Fe(III)-polysaccharide hydrogels for plants. The kale showed no signs of negative influence from the gel beads towards their germination (FIG. 21). It was observed that the hydrogel beads were stable under the greenhouse conditions for several days before degradation. Twenty days following hydrogel bead application, it was difficult to observe any hydrogel beads in the pots because of dehydration and then decomposition of the beads, indicating the photo- and chemo-degradability of the hydrogel fertilizer system.

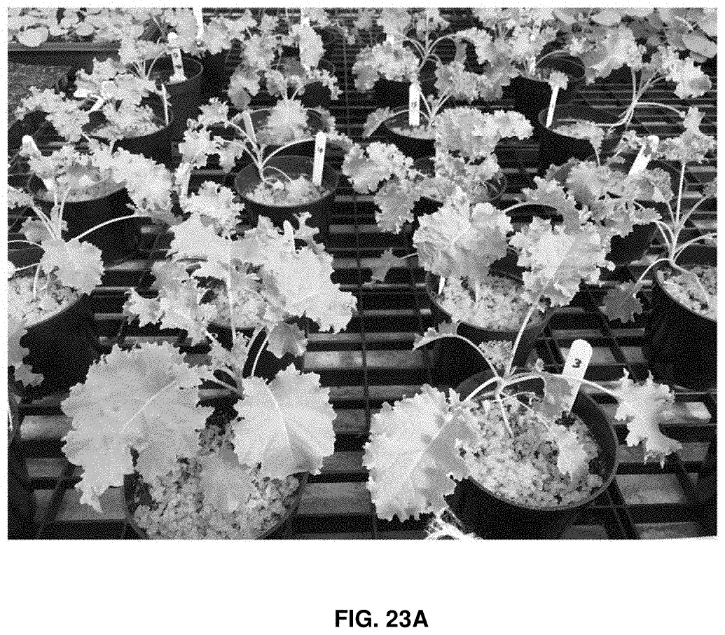

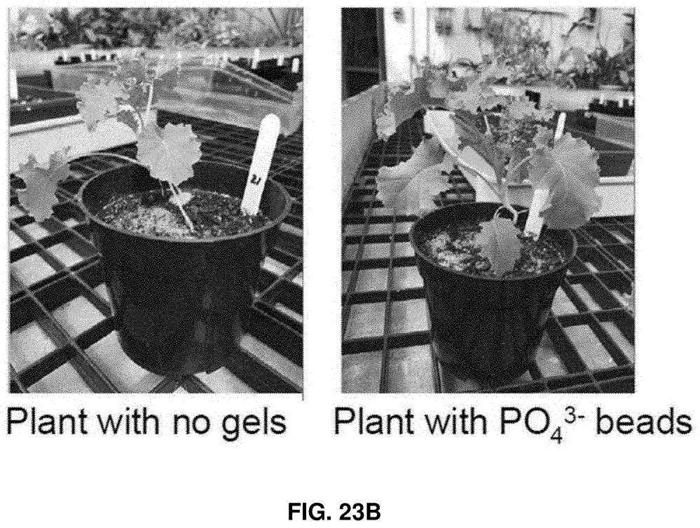

Hydrogel toxicity was further assessed during plant growth and maturation. Plant trials with kale showed similar enhanced growth in the plants that were treated with the phosphate-loaded hydrogels compared to the untreated controls (FIG. 22). Similar to the germination studies, there were no visible signs of negative effects for the plants (discoloration, etc.) from the hydrogels (FIGS. 23A-23B). During the first couple of weeks, kale plants treated with phosphate beads had an enhanced growth compared to the other plants as observed visually. By the time of harvesting (6 weeks from transplanting), the plants treated with phosphate-loaded hydrogel beads collectively showed only small differences in growth compared to the others.

Overall, comparison of the above-root biomass of the plants not treated with any beads and the plants treated with hydrogels without phosphates showed only small differences (p=0.44 and 0.08 for biomass differences of control plants, plants treated with control beads, and phosphate-loaded beads, respectively) at the 95% confidence interval (FIG. 13C). The lack of difference may be due to the presence of nutrients in the growing mix that was used such that phosphate was not limiting growth, or that the amount of phosphate added to the plants treated with phosphate beads was insufficient for enhanced growth. Furthermore, plants require other nutrients such as potassium and nitrogen sources other than phosphates, which were not provided in this experiment. While enhanced growth was not seen compared to conventional fertilizer, the phosphate loaded hydrogel system has advantages over conventional fertilizer including non-toxic components, ability to biodegrade, and controlled release mechanism using light. The phosphate loaded hydrogel system was demonstrated to be useful as a controlled release fertilizer system because of the beads' ability to biodegrade, non-toxicity towards the plants, and controlled release mechanism.

Quantitative elemental analysis was performed for the hydrogel beads using Energy Dispersive X-ray Spectroscopy (EDS) before and after soaking in the phosphate solution. It is important to note that the percent weight of each element was calculated excluding the gold and palladium, which were used to coat the samples before the experiment (Au and Pd appear at 2.12 and 2.84 in the EDS spectra, respectively). EDS showed the presence of phosphorus in the hydrogel system after the soak time, which was not seen in the virgin gel beads. (Table 3.) The virgin hydrogels did not show the presence of phosphorus element, and after the soaking, phosphorus element was present at more than 5% by weight. Also upon the soaking process, oxygen becomes the most abundant element in the system due to the additional oxygen atoms that come with the PO₄³⁻ groups.

TABLE 3
Elemental analysis of alginate G-alum-0.05M FeCl₃ hydrogel bead
interior before and after soaking in phosphate solution

| | % weight before | % weight after |
|---|---|---|
| Element | soaking in PO₄³⁻ | soaking in PO₄³⁻ |
| C | 44.30 | 31.85 |
| O | 31.26 | 40.37 |
| Fe | 19.14 | 16.66 |
| S | 2.24 | 3.15 |
| K | 1.62 | 0.47 |
| Na | 1.30 | 2.12 |
| P | 0 | 5.36 |
| Total | 99.86 | 99.98 |

Another interesting feature is that the EDS elemental analysis performed for the phosphate soaked gel bead exterior showing changes in the element percentages compared to the interior. Higher carbon percentage in the gel exterior compared to the interior along with high iron, oxygen, and phosphorus percentages in the gel interior may be due to the slight rearrangements of the dynamic hydrogel structure during the soaking in phosphate solution. Without wishing to be bound by theory, it is believed that to facilitate the negatively charged phosphate groups within the gel system, positively charged iron (III) ions tend to move towards interior of the dynamic hydrogel structure along with the carboxylate groups that they are coordinated to. This exposes the carbon polysaccharide chain towards the gel surface which causes for a high carbon percentage in the gel exterior compared to the interior. But SEM images of hydrogels soaked in phosphate solution did not show any significant differences compared to the SEM images of virgin hydrogel beads in FIGS. 18B-18C.

In summary, a system to capture phosphate ions from waste water and animal manure using natural polysaccharide materials, which can be used as a photocontrolled phosphate fertilizer for plants, has been developed. The Fe(III)-alginate hydrogel beads were composed primarily of water with a small amount of Fe(III) coordinated inside. These beads showed good phosphate uptake in the pH range of 4.0-9.0 within 24 hours in both model wastewater solutions and liquid animal waste. The uptake behavior slightly changed with the polysaccharide composition and with the concentration of Fe(III) used for gel bead preparation. Exposure of these hydrogels to light triggered the Fe(III)-carboxylate photochemistry, which resulted in degradation of the hydrogels and release of trapped phosphates. Plant trials carried out with kale plants showed that these phosphate hydrogels were useful as a light-controlled slow release fertilizer system. This Fe(III)-polysaccharide hydrogel beads system is an environment-friendly approach for reclamation of phosphate from wastewater and animal waste with an easily scalable process to create light-responsive solid fertilizers. Other than the environmental benefits, farmers can utilize the waste and reduce their fertilizer cost with this easy method to generate their own fertilizer on site.

Light Controlled Phosphate Release

Phosphate loaded hydrogel beads showed very low phosphate release under dark conditions. After 7 days, the total phosphate release was less than 1.5% and the hydrogel beads did not show any change in the appearance. (FIGS. 14A-14B.) The samples exposed to sunlight showed a 15% phosphate release with time. After 7 days the beads were degraded. The samples irradiated with the 405 nm light showed the highest phosphate release with over 80% of phosphate release after 7 days. Also, the remaining hydrogel particle contents were even less than the sunlight samples. This significant difference in sunlight and 405 nm conditions may be due to several reasons including solar spectrum containing wavelengths from ultra violet to infra-red Vs single 405 nm wave length. Furthermore, the sun light conditions were only about 14 hours per day whereas the samples irradiated with 405 nm light source were exposed to the light for 24 hours per day. Iron (II) test generation also followed the phosphate release trend, showing the iron (III)-carboxylate photochemical reaction degraded the hydrogel to generate iron (II) and release the trapped phosphate ions in to the system.

Conclusions

Iron (III) alginate hydrogel beads are mostly water with only a little bit of iron trapped inside. These beads show good phosphate uptake in the pH range of 4.0-11.0 within a 24 hour time frame. The uptake behavior slightly changes with the polysaccharide composition and with the concentration of iron used for gel bead preparation. Exposure of these hydrogels to light triggers the iron (III)-carboxylate photochemistry which results in degradation of the hydrogels and release of trapped phosphates. Plant trials carried out with kale plants showed that these phosphate hydrogels are useful as slow release fertilizer systems.

### Example II—Nutrient Capture from Aqueous Waste and Photo-Controlled Delivery Towards Plants Using Fe(III)-Alginate Hydrogel Beads

In this example, Fe(III)-alginate hydrogel beads showed a 0.05 mgg⁻¹ NH₄⁺ and NO₃ uptake from 100 ppm solutions at pH=7. No change in nutrient uptake was observed when mixed nutrient solutions with PO₄³⁻, NH₄+, and NO₃ with 100 ppm concentration from each ion was used at the same pH. When ammonium uptake from a raw manure solution with an initial concentration of 1417 ppm was studied, significant 0.7 mgg⁻¹ ammonium uptake was observed. A 14-fold increase in uptake was seen with the 14-fold increase in the waste solution showing the equilibrium between ammonium ions in solution and gels. Tomato plant trials carried out with Fe(III)-alginate hydrogel beads in greenhouse conditions showed a controlled nutrient delivery for the plants compared a fertilizer solution with same amount of nutrients. Plants showed an uptake of Fe from the gel beads and Fe(III)-alginate hydrogel beads promoted root growth of the plants.

Nitrogen and phosphorus are two major macronutrients required for plant growth, flowering, and fruit formation. Therefore, in modern day agriculture, chemical fertilizers are used in large amounts to enhance the crop yields. Soon after fertilization, a significant amount of phosphorus is precipitated as Ca, Al, and Fe complexes, making them unavailable for plant uptake. Another portion of these important nutrients are lost due to run-off, and later cause environmental issues such as harmful algal blooms. This indicates that only a small portion of nutrients are finally absorbed by the crops for the growth and development.

Application of animal manure on fields is another common practice around the world to fertilizer the farmlands. With changes in the nutrient quantity depending on the type of animals, feed, and treatment methods, manure is rich in nitrogen, phosphorus, and potassium. Animal manure amended soil contain higher phosphorus content compared to soil that are not amended with manure. Also, application of animal manure in agricultural fields contributes to the emission of ammonia and other greenhouse gases such as nitrous oxide. Furthermore, land application of concentrated animal feeding manure has other adverse effects such as impacts on fish populations and communities.

Municipal, industrial, and agricultural waste are also rich in metal ions, nitrogen, and phosphorus. Treatment of these waste solutions before releasing back to the environment or reusing is expensive. At the same time, improper management of these waste results in many adverse environmental effects including greenhouse gas emissions, eutrophication, and soil pollution. Even though these byproducts are considered as waste, reclamation of important metals and other nutrients can be economically beneficial and environmental friendly.

Conversion of animal manure into renewable fuels using thermochemical processes is one method of using them effectively. Nutrient recovery from waste water and animal manure using freshwater algae and using for biofuel production and animal feed is another approach. Capturing nitrogen and phosphorus from waste solutions to use as plant fertilizer is another approach that can address certain waste management issues as well as the increasing fertilizer demand. Studies have been done using dry algal biomass grown on animal manure as plant fertilizer.

Sewage sludge is also applied into agricultural fields due to their nutritional value. Typical treatment for sewage sludge with Fe, Ca, and Al salts decrease their water soluble P content. Studies have shown that P from animal manure and appropriately treated sewage sludge are more available for plants compared to soluble inorganic fertilizers due to the rapid retention by Fe present in soil.

As demonstrated in Example I above, Fe(III)-alginate beads are capable of up-taking phosphate ions from aqueous waste solutions, and such ions can be released with light.

Materials and Methods

Materials

Sodium alginate 35% mannuronate, Mw=97,000 Da (Alginate G) was received from Kimica Corporation. Sodium phosphate (Na₃PO₄) anhydrous, disodium hydrogen phosphate (Na₂HPO₄) anhydrous, and sodium dihydrogen phosphate (NaH₂PO₄) anhydrous were purchased from Fischer scientific. Iron (III) chloride (reagent grade 97%) and pectin from citrus peel with 74% galacturonic acid (Lot SLBN9007V) were purchased from Sigma Aldrich. Chitosan Mw 50,000-190,000 Da (Lot STBH6262) was purchased from Aldrich chemical company. Ammonium chloride min. 99.5% pure was purchased from EMD chemicals Inc. Potassium nitrate 99% pure was purchased from Acros. 200 proof ethanol was purchased from Pharmco-AAPER. Raw manure solutions were obtained from a concentrated animal feeding operation for dairy cattle in Putnam County, Ohio. Manure was used for the experiments as it is without any pretreatment and had an average pH of 7.6±0.1 and average concentrations of phosphate, ammonium, and nitrate ions of 727 ppm, 1417 ppm, and <13 ppm (less than minimum detection limit), respectively. Tomato seeds (early girl hybrid) were purchased from Ferry Morse Seed Company. Soil was collected from an agricultural research field in northwest Ohio which has not been fertilized for several years. Sungrow professional growing mix (Fafard 4 Mix Metro Mix 510), Sungrow vermiculite (premium grade), Sunshine brand coarse perlite (premium grade), and Sunshine professional growing mix (75-85% peat moss) were used for the tomato plant trials.

Hydro Gel Bead Preparation

A 1% by weight alginate G solution was prepared by dissolving sodium alginate in D.I. water. This solution was then dropped into a 0.1 M FeCl₃ solution using an 18 gauge needle. For mixed polysaccharide gels, 0.5% by weight alginate G and 0.5% by weight other polysaccharide (chitosan or pectin) was mixed in D.I water. For alginate-chitosan solutions, a 20 gauge needle was used to drop the polysaccharide solution to the 0.1 M FeCl₃ solution because of the undissolved chitosan particles.

Nutrient Uptake from Artificial Waste Solutions

Ammonium solution was prepared by dissolving ammonium chloride in D.I. water so that final NH₄⁺ concentration was 100 ppm. Nitrate solution was prepared by dissolving potassium nitrate in D.I. water to achieve a solution with 100 ppm NO₃ concentration. A mixed nutrient solution was prepared by dissolving potassium nitrate, ammonium chloride, and disodium hydrogen phosphate in D.I. water so that the concentration of NO₃⁻, NH₄⁺, and PO₄³⁻ ions were 100 ppm. The pH of these solutions was adjusted to 7.0 and 20 mL of this solution was placed in 50 mL glass beakers with 10.0 g of polysaccharide-0.1 M FeCl₃ hydrogel beads and covered with parafilms. These beakers were placed on top of Daigger 22407A mechanical shaker under dark conditions for 24 hours. Then, gel beads were filtered off and the nutrient solutions were diluted 20 times before analyzing for remaining nutrient content using the SEAL Analytical AQ2 Discrete Analyzer.

Nutrient Uptake from Raw Manure Solutions

Hydrogel samples of 10.0 g were placed in plastic cups along with 20 mL of raw manure solution and allowed to stand for 24 hours. The gel beads were then filtered and the filtrate was diluted 50 times before analyzing for the remaining nutrient content using SEAL Analytical AQ2+ Discrete Chemical Analyzer.

Thermogravimetric Analysis (TGA)

Hydrogel samples were allowed to air dry on a petri dishes under dark for 3 days. These dry hydrogel samples were ground using pestle and mortar. TG curves were collected using TA Instruments TGAQ50 with a heating rate of 10° C. per minute from room temperature to 1000° C.

Tomato Plant Trials

Tomato seeds were allowed to germinate in a tray with Sungrow professional growing mix 510. After 17 days, the plants were transplanted in plastic pots with the dimensions of 17 cm diameter and 18 cm height with ˜1.7 kg of growing mix on each pot (60% soil, 20% peat moss, 10% vermiculite, and 10% perlite by volume). A nutrient solution was prepared by dissolving 27.9 g of K₂HPO₄, 29 g of NaH₂PO₄, and 35.7 g of NH₄NO₃ in 1 L of D.I. water, and the pH was adjusted to 7.0 with a 6 M NaOH solution (12,500 ppm N, P, and K solution). This solution was used as the fertilizer solution. Fertilizer hydrogels were prepared by dissolving 1% alginate G by water weight and dropping into a 0.1 M FeCl₃ solution. Control gel beads were prepared by dissolving 1% by weight sodium alginate in D.I. water and dropping into a 0.1 M FeCl₃ solution. An automated bead maker was used to make gel beads in large quantities.

Six different growth conditions were provided to the plants, namely control plants (condition 1), treatments with fertilizer solution (condition 2), control beads (condition 3), control beads in dark (condition 4), fertilizer gels (condition 5), and fertilizer gels in dark (condition 6), with eight plants under each condition. For dark conditions, the pot was covered with aluminum foil leaving a small cut in the middle for the plant to grow out. Plants were placed in a greenhouse and watering was done three times per week with 200 mL per pot from the day of transplanting and with the growth of the plants watering frequency was increased. A 20 mL of fertilizer solution per plant was used for condition 2 and fertilizer beads obtained from 20 mL of fertilizer solution was added for each plant in condition 5 and 6 so that same amount of nutrients were provided for conditions 2, 5, and 6. Fertilizer solution and beads were added every two weeks since transplanting in pots and six times during the experiment. Since differences in plants were observed under different conditions, starting from the 8^{th} week, plant height, number of flowers, and number of fruits in each plant were recorder every week. Ripened fruits were harvested and weighed for comparison.

Chlorophyll Content Analysis in Tomato Leaves

Chlorophyll content of tomato plants were determined according to a method reported before with appropriate modifications. In brief, tomato leaf disks with a diameter of 16 mm were punched out from a matured leaf of each three months old plant. Each disk was then placed in a 20 mL glass vial with 10 mL of 200 proof ethanol. These vials were stored under dark for 24 hours and the alcohol solutions were collected in to 50 mL volumetric flasks. Each vial was rinsed with 5 mL ethanol and the washing was added to the same volumetric flask. The same procedure was continued for two more days and the solution was collected to the same 50 mL volumetric flask. After combining the three extracts, ethanol was added to dilute up to the mark and the absorbance of these solutions were measured at 649 nm and 665 nm wavelengths using Shimadzu UV-2600 UV-vis spectrophotometer. The chlorophyll a and b content for each leaf sample was calculated using the following equations:

$$\begin{matrix}\frac{µg of Chlorophyll a}{mL of solution} = ( 13.70 ) ( A 665 nm ) - ( 5.76 ) ( A 649 nm ) & ( 1 ) \\ \frac{µg of Chlorophyll b}{mL of solution} = ( 25.80 ) ( A 649 nm ) - ( 7.60 ) ( A 665 nm ) & ( 2 )\end{matrix}$$

Total chlorophyll content was obtained by adding chlorophyll a and b weights and total chlorophyll per unit area of leaf was calculated.

Biomass Analysis of Tomato Plants

After 16 weeks from seed germination, tomato plants were destructively harvested and root and shoot systems were separated and the biomass was calculated according to a previously reported method. In brief, plant materials were dried at 80° C. for at least 48 hours and the dry weights of root and above ground biomass were recorded.

Fe and P Content Analysis with ICP-MS

Dry tomato leave samples from condition 1, 2, 5, and 6 were analyzed for Fe and P content.

Results and Discussion

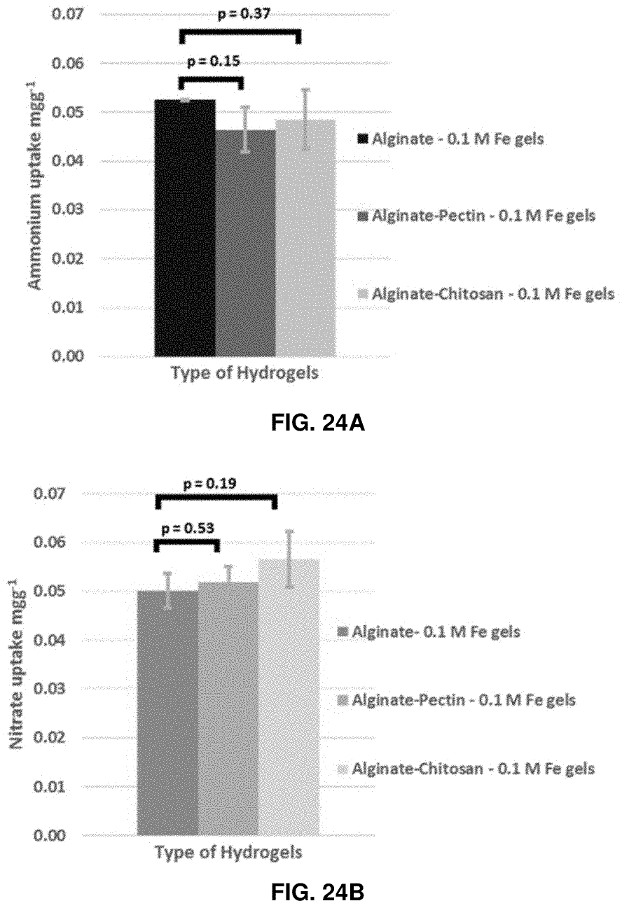

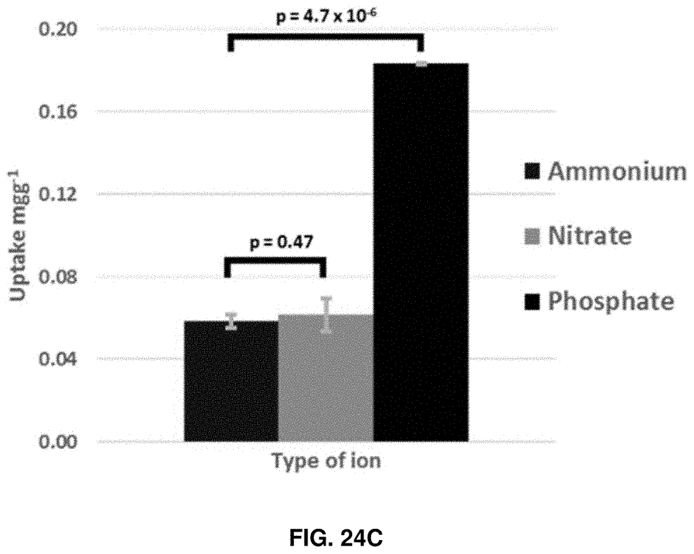

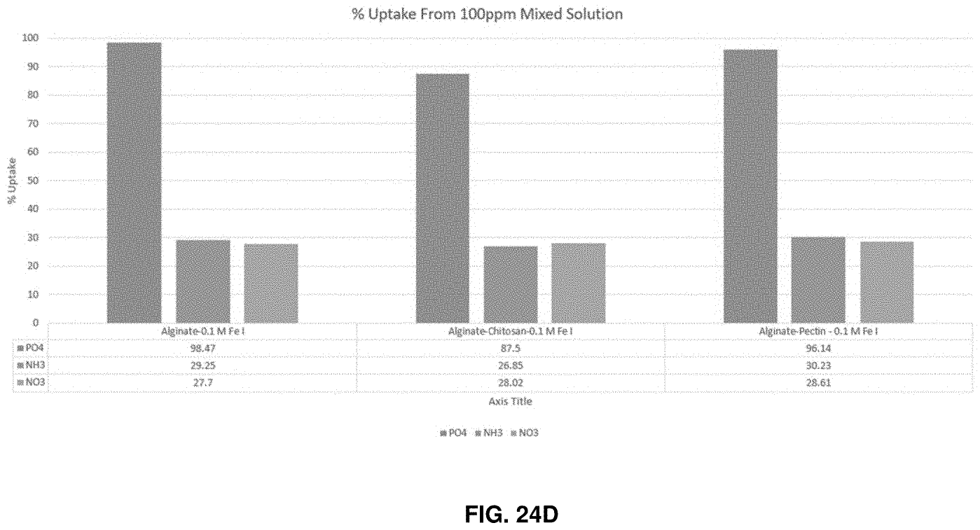

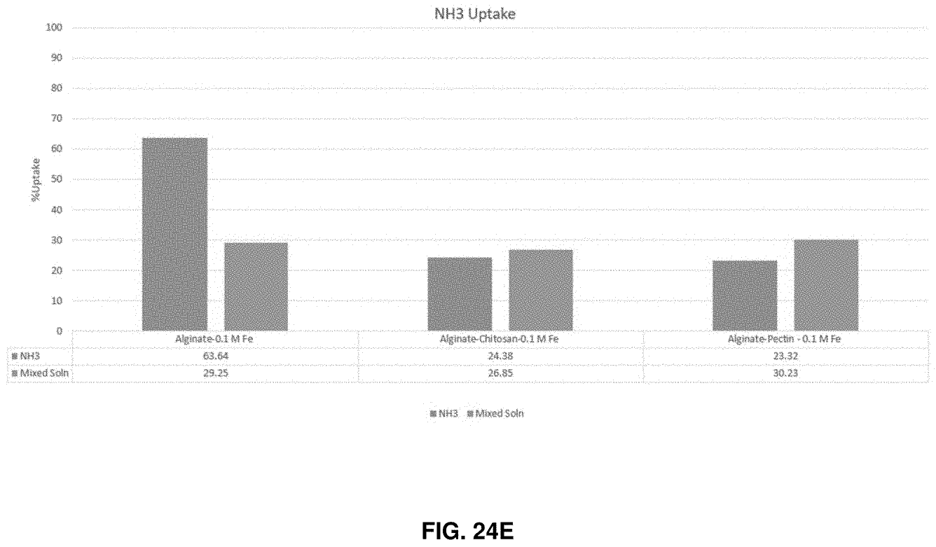

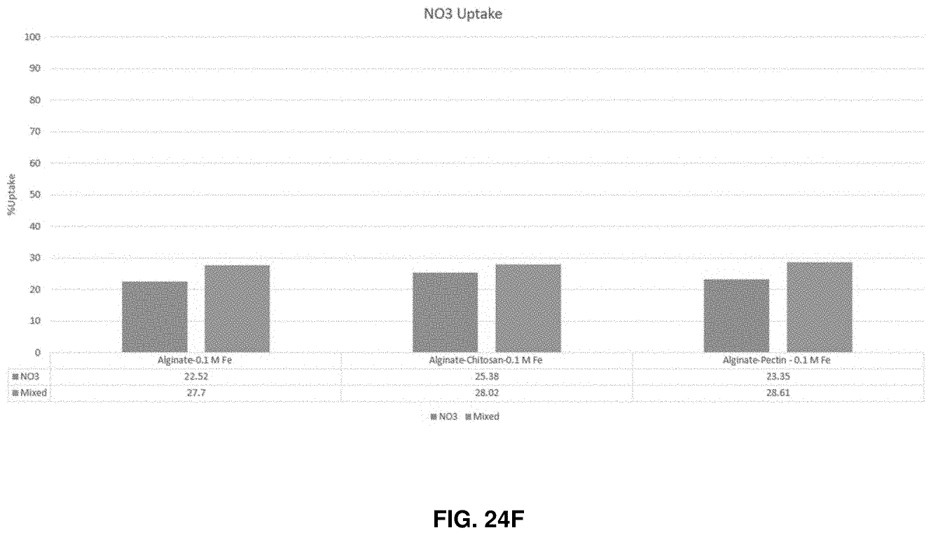

The polysaccharide-0.1 M Fe gel beads showed ammonium uptake around 0.05 mgg⁻¹ for all three types of gel beads studied. (FIG. 24A.) This is an uptake of about 27% of ammonium ions from the initial 100 ppm solution. Similarly, all three types of hydrogels had a nitrate ion uptake over 0.5 mgg which corresponded to about 32% of nitrate ions from the initial 100 ppm solution. (FIG. 24B.)

Interestingly, these nitrate and ammonium ion uptake values did not change much when the experiments were carried out with the mixed nutrient solutions which had ammonium, nitrate, and phosphate ions in the same solution (FIG. 24C). This indicates that the uptake of NH₄⁺, NO₃⁻ ions to alginate—Fe hydrogel beads was not affected by the presence of other ions. Furthermore, the phosphate uptake from the mixed solution was around 0.18 mgg⁻¹ for all three types of beads (more than 90% of uptake), which is three times higher than the nitrate uptake. This indicates that trivalent phosphate ions can bind stronger to the hydrogels than the monovalent nitrate ions, and the possible binding site would be the Fe(III) ions of the hydrogels.

In Example I above, it is shown that these alginate—Fe hydrogels can uptake over 1 mgg⁻¹ phosphate, and it depends on the phosphate concentration of the solution which affects the equilibrium. Also, using artificial solutions with similar phosphate concentrations and pH values to dairy manure solutions, it was shown that phosphate uptake was also not affected by the presence of other ions and dissolved solids. Other than that, it was observed that with 100 ppm phosphate solutions, the phosphate uptake was around 0.2 mgg⁻¹ which corresponded to about 99% of the initial phosphate in solution. With the increased phosphate concentrations, the phosphate uptake value went over 1 mgg⁻¹ while percent phosphate uptake went down, showing a saturation of phosphate binding in the hydrogels. In this example, a different trend for ammonium ions was observed where the ammonium uptake from the raw manure solution (initial NH₄⁺ concentration of 1417 ppm, pH=7.6±0.1) was as high as 0.7 mgg¹, which accounted for about 26% ammonium ions from the initial solution (FIG. 24C). The ammonium ion uptake from hydrogel beads went up from 0.05 mgg⁻¹ for the 100 ppm artificial solution to 0.7 mgg⁻¹ for manure solution, which had an average ammonium concentration of 1417 ppm. The 14-fold increase in ammonium concentration generated a 14-fold increase in the ammonium uptake value in mgg¹, showing the equilibrium between the solution and bound ammonium. The concentration increase did not saturate the ammonium binding. The nitrate content in the manure solution was very low (<13 ppm) and therefore the trends could not be compared.

Other than the analysis of the artificial nutrient solutions after the soak process as an indirect method for nutrient uptake, TGA was performed on the gel beads after drying. TGA of alginate—0.1 M beads showed a sharp drop around 200-300° C. due to the decomposition of alginate. Upon soaking of the hydrogels in artificial waste solutions, differences were observed in their TGA curves. Hydrogels soaked in ammonium solution showed rapid weight loss and low final weight percent compared to the as-it-is hydrogels showing the release of ammonia during the heating. On the other hand, hydrogels soaked in nitrate solution also had a different thermal stability and the final weight percent was again lower than as-it-is hydrogels due to the loss of nitrate ions. Dry gel samples soaked in phosphate solution and mixed nutrient solution were also different from the as-it-is hydrogel sample. Interestingly, their final weight percent was higher than the as-it-is hydrogel sample showing the coordinated phosphate ions were left even after the heat treatment.

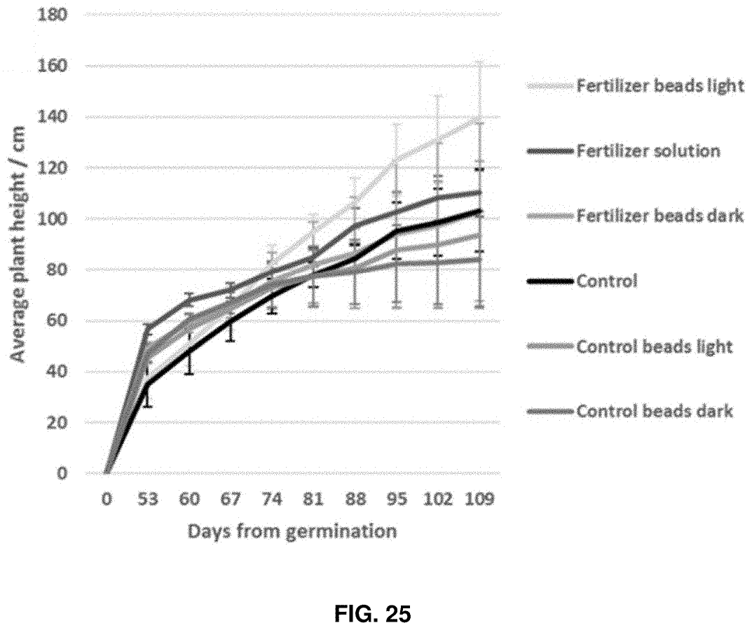

Plant trials were carried out with tomato (Solanum lycopersicum) plants to study the nutrient release from the hydrogels and the effect of light on the release (FIG. 25A). Average plant height under each condition was monitored as a measure of the plant growth every week since plants started showing significant changes (FIG. 16D). Plants treated with fertilizer solution were taller than all the other conditions during the first 9 weeks of the experiment. Plants treated with fertilizer hydrogel beads had similar heights to the other plants during the first few weeks. Around week 10, these plants started showing a significant growth and by the end of the experiment (day 109), the average height was 140±21 cm, which was 20 cm taller than the plants treated with fertilizer solution which ended as second. Control plants and the plants treated with fertilizer beads in dark were having similar heights at the end of the experiment. This showed that NH₄⁺ and NO₃⁻ nutrients in fertilizer solution were readily available for the plants to absorb and the plants treated with fertilizer solution got a start booster. At the same time, these readily available nutrients are a major cause for adverse environmental effects of fertilizer such as harmful algal blooms. On the other hand, the fertilizer beads were holding the nutrients and releasing them slowly for the plant. The pots covered with aluminum foil to keep the beads in dark had an average height of 103±35 cm, which is 37 cm shorter than the ones which were exposed to sunlight. This shows that the exposure to light accelerated the photo release due to the Fe(III)-carboxylate photochemical reaction.

Tomato plants started forming fruits in the 8^{th} week of the experiment. Significant differences were observed in fruit formation of tomato plants for different treatments (FIG. 16A). Plants treated with fertilizer solution were in the lead during the entire experiment. This can be attributed to the readily available phosphate ions from the fertilizer solution. Similar to the plant height data, both treatments with fertilizer hydrogel beads were in second and third, with hydrogel beads exposed to light showing the better results due to photodegradation and nutrient release. Plants in condition 5 were producing a lot of fruit during the latter part of the experiment, and that condition produced more than the condition 2 which was in the lead, similar to what was observed in plant height. This shows that the release of phosphates (major contributor for fruits) are slower than release of ammonium and nitrates (major contributor for plant growth) from the fertilizer beads. This can be explained by the strong binding of phosphates to Fe within the hydrogel controlling the phosphate release, whereas ammonium and nitrate had faster release with hydrogel degradation because they were trapped inside the hydrogels due to electrostatics and other weaker binding forces.

Other than plant height as a numerical data for the plant growth, the plant growth was visually observed. Plants treated with fertilizer solution produced the bushiest plants with the most number of branches and leaves. Even the length of the leaves was highest for this condition due to the readily abundant nitrogen sources. Two conditions with fertilizer beads (5 and 6) were next, showing better growth over the controls. The growth of the plants from condition 2 was so excessive and it made the fruits to compete with the leaves and other parts of the plant for nutrients and water.

High ammonium activity and fruits not getting enough calcium and water (due to the competition with other parts of the plant) are contributing factors for blossom end rot of tomatoes. Some of the fruits from condition 2 suffered blossom end rot due to the excessive nutrient availability (FIGS. 17B-17C). Even though the same nutrient content was used for plants with fertilizer beads, this was not observed due to the controlled release of nutrients which resulted in somewhat controlled growth. Blossom end rot turned the bottom of the tomato into a dark color and eventually dried out that area of the fruit to reduce the weight of the fruit and make them not consumable.

Even though condition 2 produced the most number of fruits, the average ripened fruit weight from this condition was low. (FIG. 17A.) Drying out the bottom of the tomato due to blossom end rot was part of the reason for this. Other than that, some fruits from condition 2 ripened when the fruits were small in size. Higher nitrogen and phosphorus nutrients increase the production of lycopene, the natural pigment that gives the red color for tomatoes. This was not seen in any other condition and these small ripened fruits contributed for the average ripened fruit weight to go down for this treatment. Again, this showed the gel beads in condition 5 and 6 were releasing the nutrients in a slow manner to avoid the high lycopene formation.

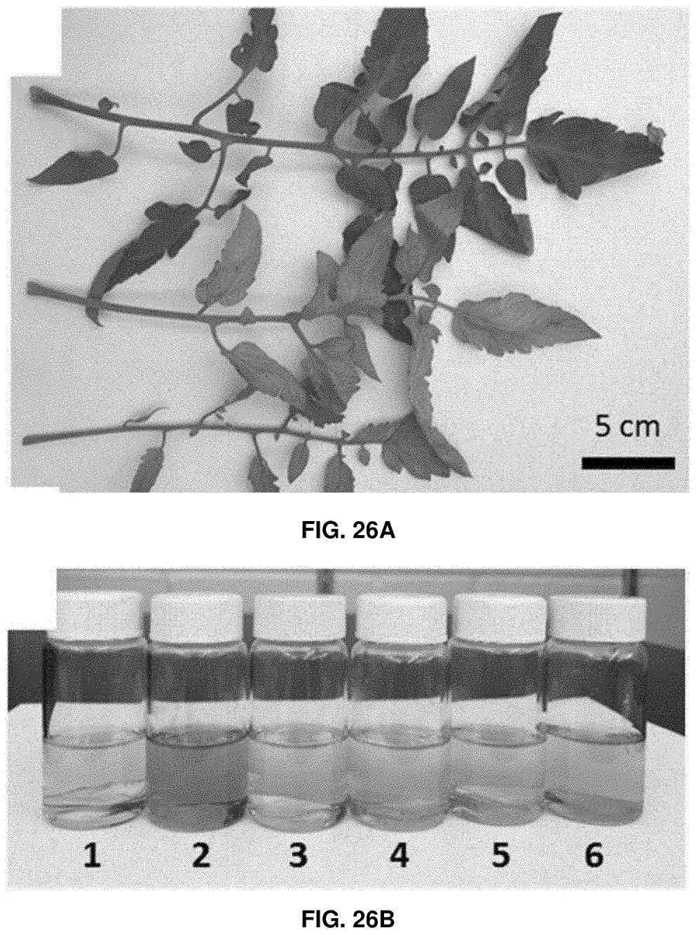

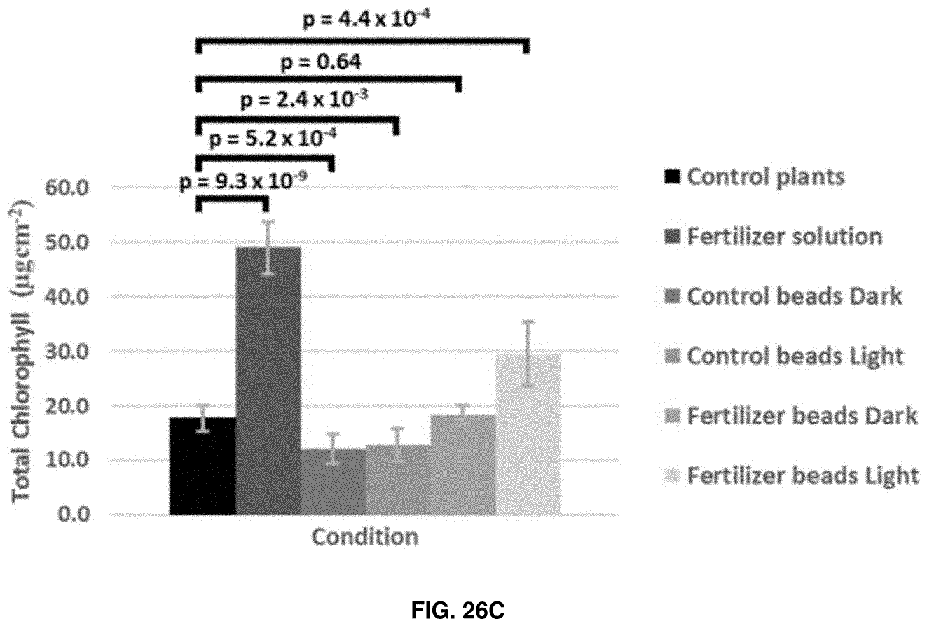

Significant changes were observed in the green color of the tomato leaves from different conditions (FIG. 26A). To gain quantitative data for these observations, chlorophyll was extracted using ethanol as the solvent. After the extraction, clear differences were visible in the green color of the extracts from several treatments (FIG. 26B). A colorimetric analysis for total chlorophyll content was performed for leaf samples. The total chlorophyll content in condition 2 was a lot higher than all the others, and condition 5 was clearly in second (FIG. 26C). The plants treated with control beads (both dark and light) had lesser total chlorophyll content compared to the control plants, indicating that control hydrogel beads may have some effect towards the chlorophyll formation of the plant.

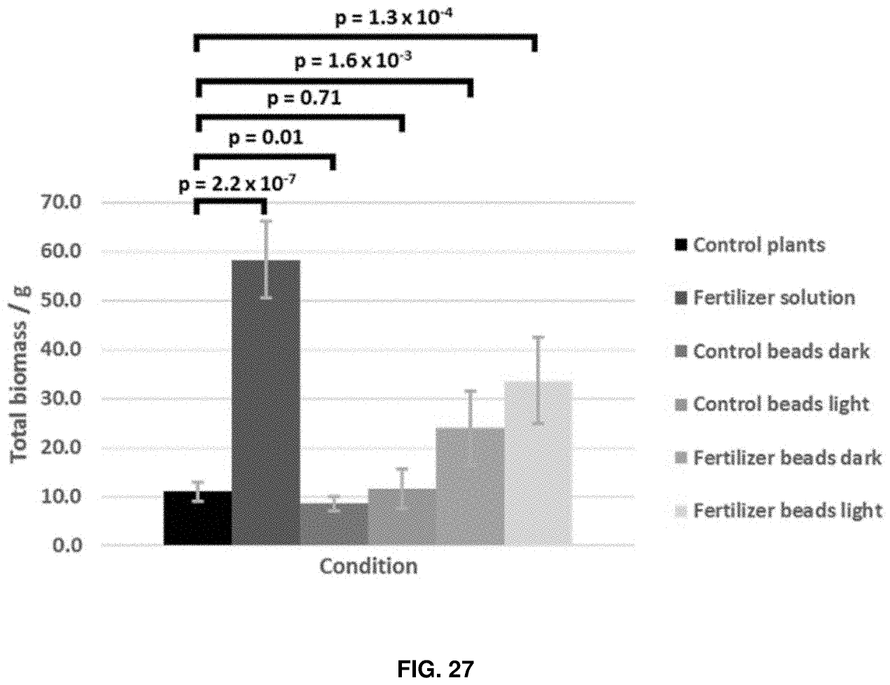

After the end of the experiment, plant materials were dried to compare the biomass of plants. Above ground biomass and below ground biomass were calculated separately and total biomass for each condition was calculated (FIG. 27). Similar to the previous observations, the total biomass was highest for condition 2, and conditions 6 and 5, which were treated with fertilizer beads, were next. (FIG. 27.) Above ground biomass and below ground biomass followed the same trend as the total biomass.

The below ground biomass data indicated that plants treated with fertilizer hydrogel beads promoted the root growth more than it helped the growth of the plant shoot system. Previous work with tomato plant had shown that Fe promotes the root growth of tomato plants. Therefore, the Fe present in the hydrogel beads is believed to promote the root growth. The shoot to root ratio (SR ratio) was calculated for the average biomass data and this clearly showed that Fe is promoting the root growth. Plants treated with fertilizer hydrogel beads had the lowest SR ratio, and plants treated with control beads had the second lowest. Control plants had the highest SR ratio due to low nutrient content and Fe content to promote root growth.

ICP-MS analysis was performed on leaf samples from conditions 1, 2, 5, and 6 for Fe and P content. Phosphorus analysis showed that compared to the control plants, other three analyzed conditions had higher phosphorus content. An interesting feature was samples from conditions 5 and 6 had higher phosphorus content than condition 2. This may be due to both high phosphate run off from readily available phosphate ions upon watering in condition 2 as well as high phosphate consumption for fruit formation in condition 2. Regardless, the plants treated with fertilizer beads having high phosphorus content demonstrated that the fertilizer beads released the phosphate ions so that plant could uptake them. The Fe analysis data showed that the leaf samples of first two conditions had very low Fe content. This is from the soil as well as possible contaminating Fe present in the chemicals used for the fertilizer solution. The high Fe content in leaf samples from conditions 5 and 6 are due to the Fe(III) that was used for fertilizer hydrogel bead preparation. This shows that the hydrogel beads degraded and the plants were able to absorb nutrients as well as Fe from soil. Therefore, the use of this fertilizer system on crops will increase the Fe content in plants, which is beneficial. Other than addressing the harmful environmental effects, the fertilizer system may be a solution to address Fe deficiency anemia, which is a very common amongst modern day people.

In conclusion, Fe(III)-alginate hydrogel beads showed an average ammonium and nitrate uptake of 0.05 mgg⁻¹ from artificial solutions with a concentration of 100 ppm at pH=7. A 14-fold increase for ammonium uptake was observed when a manure solution with an ammonium concentration of 1417 ppm, showing the equilibrium of ammonium ions in solution and hydrogels. The nutrient uptake was not affected by the presence of other ions when studies were conducted with mixed nutrient solutions at the same pH. The ability to release plant nutrients from these hydrogel beads was studied with tomato plants under greenhouse conditions. These experiments showed that hydrogel beads released nutrients to the plants in a slower manner compared to a nutrient solution where nutrients were readily available. Light plays a role towards the nutrient release due to the Fe(III0-carboxylate photochemistry occurring in these hydrogels, and plants treated with hydrogels showed enhanced root growth due to Fe.

### Example III—Hydrogel Beads with Calcium and Iron

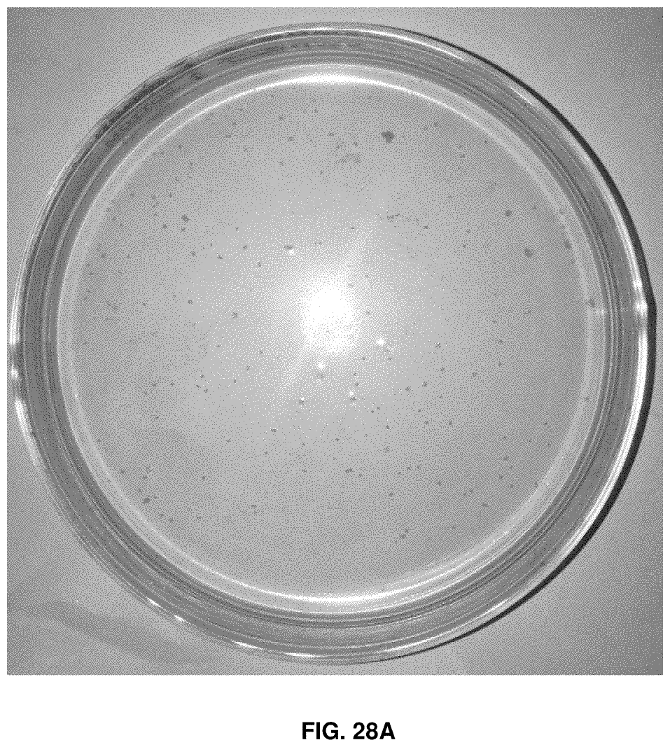

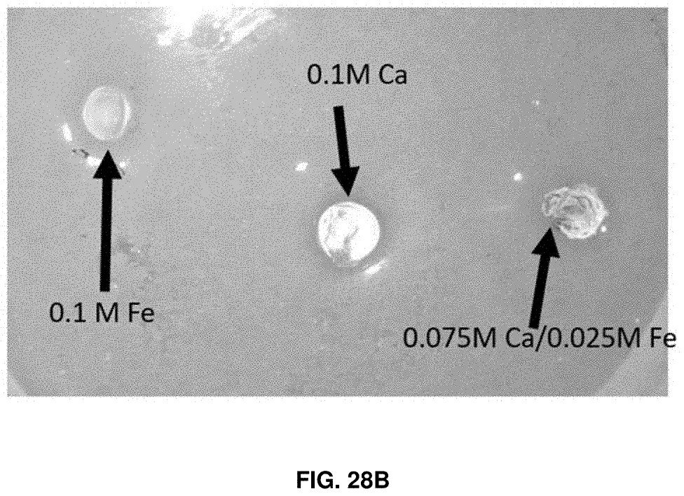

Hydrogel beads were prepared as described above except with calcium in addition to iron. Furthermore, hydrogel beads were prepared with only calcium (i.e., without iron). FIG. 28A shows a photograph of the hydrogel beads degraded after 2-3 days. FIG. 28B shows a photograph comparing the appearance of a 0.1 M Fe hydrogel bead, a 0.1 M calcium hydrogel bead, and a 0.075 M Ca/0.025 M Fe hydrogel bead. In tests, it was observed that the hydrogel beads containing calcium and iron exhibited a quicker photorelease of loaded nutrients compared to hydrogel beads with only iron.

### Example IV—Rain Simulation

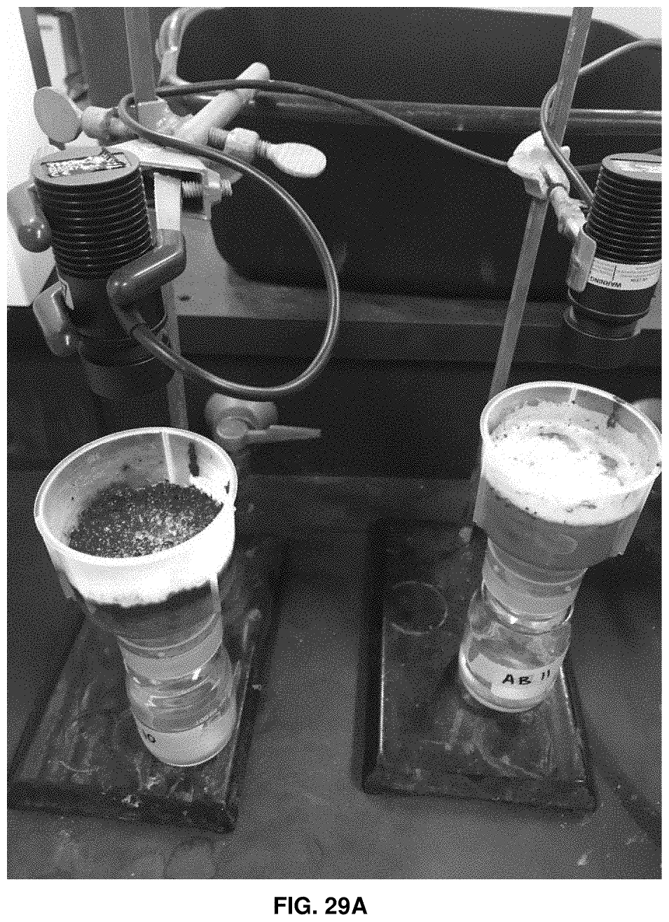

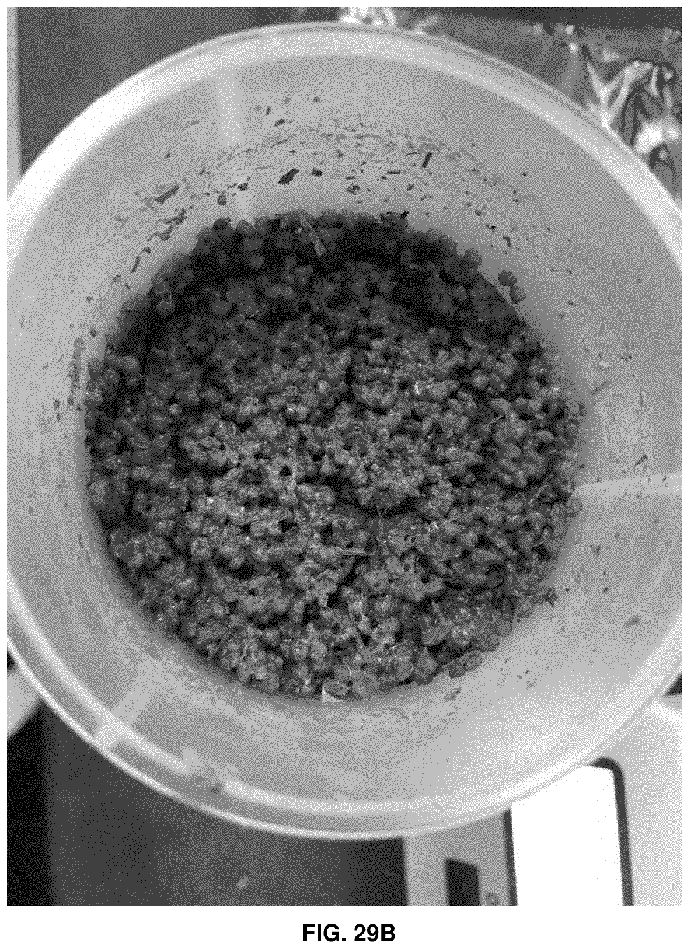

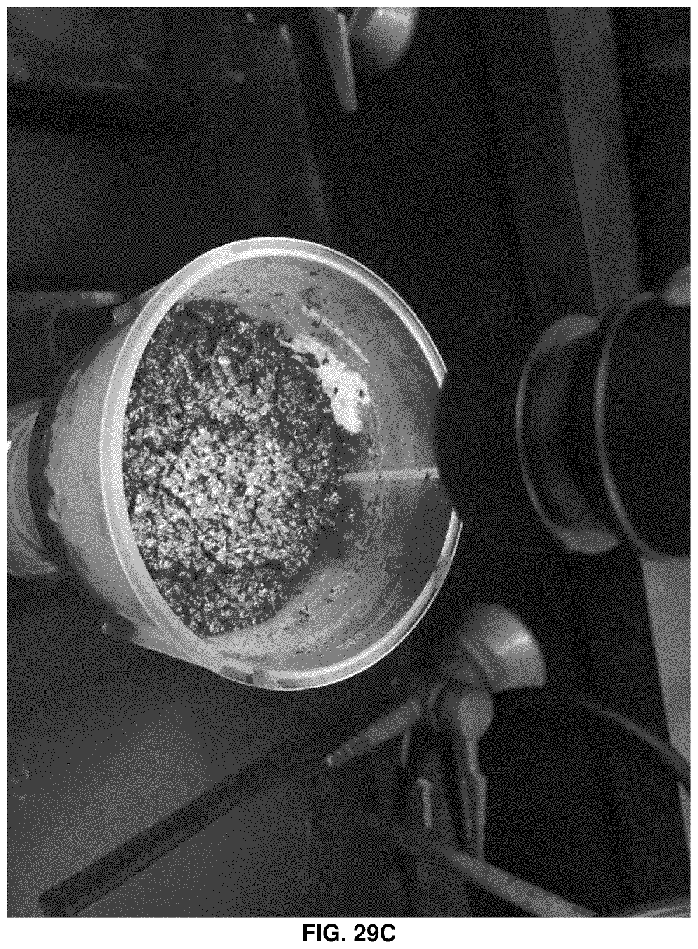

Hydrogel beads were exposed to simulated rain to simulate conditions in an agricultural field. FIGS. 29A-29C show photographs of this experiment. As seen in FIG. 29B, the hydrogel beads did not degrade from the simulated rain. Thus, the hydrogel beads are capable of withstanding an outdoor environment such as an agricultural field.

### Example V—Packed Column of Hydrogel Beads

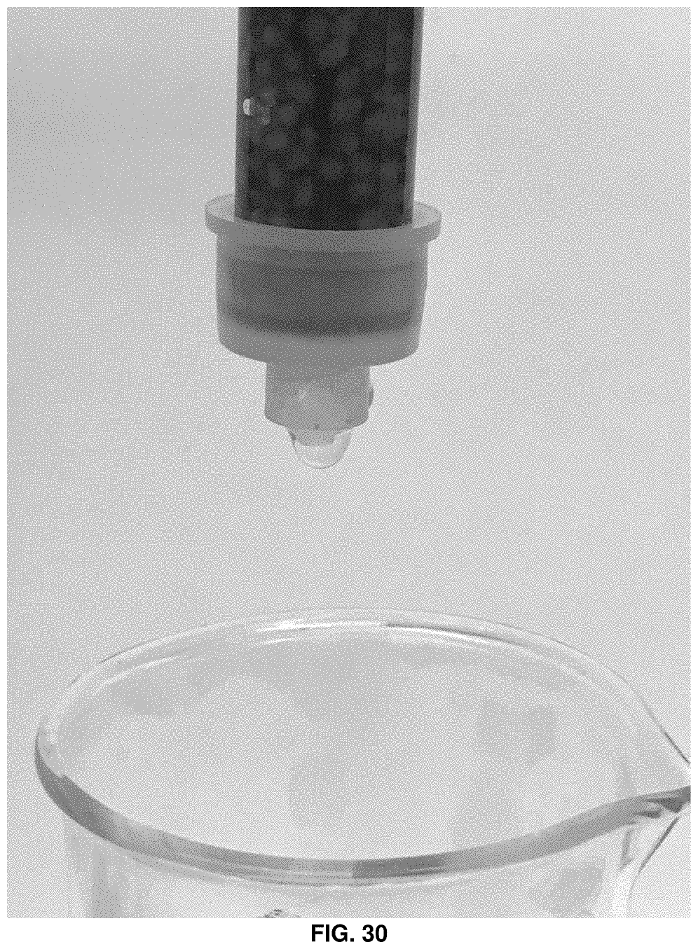

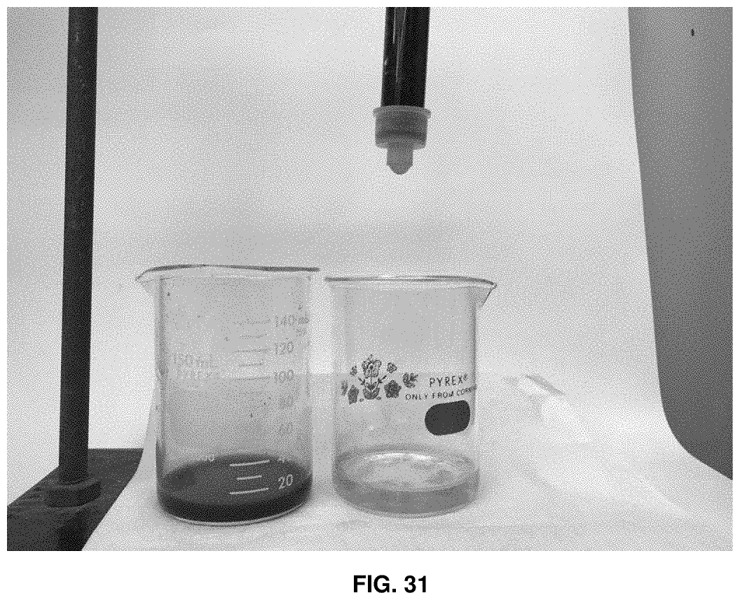

Hydrogel beads were packed in a colum and a manure solution was run through the column to load the hydrogel beads with phosphate. FIG. 10 shows a photograph of the column packed with hydrogel beads and cow manure. FIG. 30 shows a photograph of the tip of the column with the manure solution passing through the column. FIG. 31 is a photograph showing the manure solution prior to passing through the column in the beaker on the left, and the manure solution after having passed through the column in the beaker on the right. FIG. 4B is a photograph showing the hydrogel beads removed from the column after being loaded with phosphate from the manure solution. The hydrogel beads successfully uptook phosphate from the manure solution after the manure solution was passed through the column packed with the hydrogel beads.

### Example VI—Alternative Preparation Processes

Polysaccharide solution was prepared by dissolving 1% by weight sodium alginate or 0.5% sodium alginate and 0.5% other polysaccharide (pectin or chitosan) in water (example 1 g of sodium alginate dissolved in 100 mL of water or 0.5 g of sodium alginate and 0.5 g of pectin dissolved in 100 mL of water). This solution was degassed by using a sonicator. Iron (III) chloride solution with a concentration of 0.1 M was prepared. Then, x volume of the polysaccharide solution was dropped in to 2× volume of iron(III) chloride solution using a syringe and needle (20 gauge) or with a small scale hydrogel bead maker Upon dropping, the hydrogel beads were formed within a few seconds. The hydrogel beads were allowed to sit in the iron(III) chloride solution for 5 more minutes and then filtered out.

Then, hydrogel beads were soaked in a manure solution (or an artificial nutrient solution rich in phosphates, nitrates, and ammonium ions) for 24 hours with mechanical shaking, and nutrient-loaded hydrogel beads were obtained.

Hydrogel beads were allowed to dry at 45° C. for 6 hours to obtain dry nutrient loaded gel beads.

Preparation of Manure Beads Directly

Exactly weighed 1 g of sodium alginate was added to a 100 mL portion of raw manure solution slowly while mixing using the vortex. Then the alginate-manure solution was dropped in to 200 mL of 0.1 M iron(III) chloride solution using a 18 gauge needle and a syringe. The hydrogel bead formation took place within seconds and the hydrogel beads were allowed to sit in solution for 5 more minutes before filtering and separating the beads from the solution.

The manure beads could also be dried at 45° C. for 6 hours to obtain dry manure beads.

Preparation of Alginate-Manure Cakes

A 1% by weight sodium alginate solution was prepared by dissolving 1 g of sodium alginate in 100 mL of water. This solution was then mixed with 100 mL of 0.1 M iron(III) chloride solution and 100 mL of raw manure solution. Then, this solution mixture was mixed thoroughly and vacuum filtered to separate the solids from solution. The solid filtrate was allowed to air dry to obtain the dry alginate-manure cakes.

Certain embodiments of the compositions and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

1. A slow releasing fertilizer system comprising:
a hydrogel bead comprising a polysaccharide and a metal species; and
one or more plant nutrients encapsulated in the hydrogel bead;
wherein the hydrogel bead is capable of releasing the one or more plant nutrients upon exposure to light at a wavelength of shorter than 450 nm.

2. The slow releasing fertilizer system of claim 1, wherein the metal species comprises iron (III).

3. The slow releasing fertilizer system of claim 1, wherein the metal species comprises a combination of iron and calcium or a combination of iron and aluminum.

4. (canceled)

5. The slow releasing fertilizer system of claim 1, wherein the hydrogel bead comprises at least about 90% water.

6. (canceled)

7. The slow releasing fertilizer system of claim 1, wherein the metal species is present in the hydrogel bead in a range of from about 0.01% by weight to about 0.3% by weight.

8. (canceled)

9. The slow releasing fertilizer system of claim 1, wherein the one or more plant nutrients comprises a phosphate, a nitrate, or ammonium.

10-11. (canceled)

12. The slow releasing fertilizer system of claim 1, wherein the one or more plant nutrients comprises two or more of a phosphate, a nitrate, and ammonium.

13. The slow releasing fertilizer system of claim 1, wherein the polysaccharide is present in the hydrogel bead in an amount of about 1% by weight.

14. The slow releasing fertilizer system of claim 1, wherein the polysaccharide comprises a polyuronic acid.

15. The releasing fertilizer system of claim 14, wherein the polyuronic acid comprises alginate, pectate, pectin, xanthan gum, gum Arabic, oxidized starch, hyaluronate, mannuronate, or a combination thereof.

16. The slow releasing fertilizer system of claim 1, wherein the hydrogel bead further comprises a second polysaccharide or water soluble polymer comprising acrylamide or acrylic acid,
wherein the second polysaccharide comprises agarose, chitosan, or a combination thereof.

17-25. (canceled)

26. A method for making a nutrient-loaded hydrogel, the method comprising:
dissolving a polysaccharide in water to make a polysaccharide solution;
combining the polysaccharide solution with an iron chloride solution to form hydrogel beads;
separating the hydrogel beads from solution; and
soaking the hydrogel beads in a nutrient solution for a period of time to obtain a nutrient-loaded hydrogel.

27. The method of claim 26, wherein the soaking comprises mechanical shaking for the period of time.

28. The method of claim 26, further comprising filtering the nutrient-loaded hydrogel out of solution.

29. The method of claim 26, wherein the polysaccharide comprises a polyuronic acid.

30. The method of claim 29, wherein the polyuronic acid comprises alginate, pectate, pectin, xanthan gum, gum Arabic, oxidized starch, hyaluronate, mannuronate, or a combination thereof.

31. The method of claim 29, wherein the polysaccharide further comprises chitosan, agarose, or a combination thereof.

32. The method of claim 26, wherein the nutrient solution is a manure solution.

33. The method of claim 26, wherein the nutrient solution comprises phosphates, nitrates, or ammonium ions.

34. A method for reclaiming phosphate, the method comprising soaking hydrogel beads in an animal waste solution so as to cause the hydrogel beads to uptake phosphate from the animal waste solution and thereby obtain phosphate-loaded hydrogel beads, and using the phosphate-loaded hydrogel beads to fertilize a plant.

35. The method of claim 34, wherein the hydrogel beads comprise iron.

36. The method of claim 34, wherein the hydrogel beads comprise a polysaccharide.

37. The method of claim 36, wherein the polysaccharide comprises a polyuronic acid.

38. The method of claim 37, wherein the polyuronic acid comprises alginate, pectate, pectin, xanthan gum, gum Arabic, oxidized starch, hyaluronate, mannuronate, or a combination thereof.

39. The method of claim 36, wherein the polysaccharide further comprises chitosan, agarose, or a combination thereof.

40-42. (canceled)

43. A slow releasing fertilizer system comprising:
a hydrogel bead comprising a polysaccharide and a metal species; and
one or more plant nutrients encapsulated in the hydrogel bead;
wherein the metal species is capable of being oxidized or reduced upon exposure to light so as to cause a release of the one or more plant nutrients from the hydrogel bead.
